(19) United States
(12) Patent Application Publication
(10) Pub. No.: US 2021/0323092 A1
(43) Pub. Date: Oct. 21, 2021

(54) ADDITIVE MANUFACTURING APPARATUS AND ADDITIVE MANUFACTURING METHOD

(71) Applicant: Mitsubishi Electric Corporation, Tokyo (JP)

(72) Inventors: Daiji MORITA, Tokyo (JP); Nobuhiro SHINOHARA, Tokyo (JP); Yoshikazu NAKANO, Tokyo (JP); Yoshikazu UKAI, Tokyo (JP)

(73) Assignee: Mitsubishi Electric Corporation, Tokyo (JP)

(21) Appl. No.: 17/270,454

(22) PCT Filed: Apr. 4, 2019
(86) PCT No.: PCT/JP2019/015036

§ 371 Date: Feb. 23, 2021

(30) Foreign Application Priority Data
Oct. 19, 2018 (JP) 2018-197800

(51) Int. Cl. B23K 26/342; B23K 26/12; B33Y 10/00; B33Y 30/00; B33Y 50/02

(52) U.S. Cl. CPC B23K 26/342; B23K 26/123; B33Y 50/02; B33Y 30/00; B33Y 10/00

(57) ABSTRACT

An additive manufacturing apparatus includes: a material supply unit that supplies a build material to a process area of an additive target surface; an irradiation unit that irradiates the process area with a laser beam that melts the build material; and a control device that controls the material supply unit and the irradiation unit for creating at least a part of an object using a dot-shaped bead, the dot-shaped bead being formed of the build material melted by radiation of the laser beam. The additive manufacturing apparatus can improve the shape accuracy of the object.

### FIELD

The present invention relates to an additive manufacturing apparatus and an additive manufacturing method for wire-feed additive manufacturing and working.

### BACKGROUND

A known example of a conventional technique for creating a three-dimensional solid object is an additive manufacturing apparatus that uses a technique called additive manufacturing (AM). Patent Literature 1 discloses an additive manufacturing system for producing an object having a desired shape by repeatedly melting a wire into a droplet shape and depositing wire droplets on a workpiece. In the additive manufacturing system described in Patent Literature 1, a current is supplied to the welding material wire, whereby molten droplets are formed at the end of the welding material wire. Then, molten droplets are deposited in a molten pool formed on the surface of the workpiece, whereby an object is formed.

### CITATION LIST

### Patent Literature

Patent Literature 1: Japanese Patent Application Laid-open No. 2016-179501

### SUMMARY

### Technical Problem

For the additive manufacturing system described in Patent Literature 1, a current to be supplied to the wire is controlled to thereby melt the wire and separate droplets from the wire. In this case, if an arc discharge occurs between the wire and the workpiece, the workpiece may be destroyed. For this reason, the additive manufacturing system described in Patent Literature 1 needs to control the current to be supplied to the wire, in such a manner as to prevent occurrence of an arc discharge between the wire and the workpiece, which results in a long melting time. The longer the melting time is, the larger the droplets are, which causes a problem of a deterioration in the shape accuracy of the object.

The present invention has been made in view of the above, and an object thereof is to obtain an additive manufacturing apparatus capable of improving the shape accuracy of an object.

### Solution to Problem

To solve the problem and achieve the object, an additive manufacturing apparatus according to the present invention is an additive manufacturing apparatus to create an object on an additive target surface of a workpiece. The additive manufacturing apparatus comprises: a material supply unit to supply a build material to a process area of the additive target surface; an irradiation unit to irradiate the process area with a laser beam to melt the build material; and a control device to control the material supply unit and the irradiation unit for creating at least a part of the object, using a dot-shaped bead, the dot-shaped bead being formed of the build material melted by radiation of the laser beam.

### Advantageous Effects of Invention

The additive manufacturing apparatus according to the present invention can achieve the effect of improving the shape accuracy of an object.

### BRIEF DESCRIPTION OF DRAWINGS

FIG. 1 is a diagram illustrating an additive manufacturing apparatus according to a first embodiment of the present invention.

FIG. 2 is a schematic diagram for explaining a process area according to the first embodiment of the present invention.

FIG. 3 is a block diagram illustrating the hardware configuration of a control device according to the first embodiment of the present embodiment.

FIG. 4 is a flowchart for explaining the operation of the additive manufacturing apparatus according to the first embodiment of the present invention.

FIG. 5 is a schematic cross-sectional diagram illustrating the process area of the additive manufacturing apparatus illustrated in FIG. 1.

FIG. 6 is a schematic cross-sectional diagram in which the end of a wire discharged to the process area of the additive manufacturing apparatus illustrated in FIG. 1 is in contact with an additive target surface.

FIG. 7 is a schematic cross-sectional diagram in which the process area of the additive manufacturing apparatus illustrated in FIG. 1 is irradiated with a laser beam.

FIG. 8 is a schematic cross-sectional diagram in which the supply of the wire to the process area of the additive manufacturing apparatus illustrated in FIG. 1 is started.

FIG. 9 is a schematic cross-sectional diagram in which the wire is pulled out from the process area of the additive manufacturing apparatus illustrated in FIG. 1.

FIG. 10 is a schematic cross-sectional diagram in which the irradiation of the process area of the additive manufacturing apparatus illustrated in FIG. 1 with the laser beam is stopped.

FIG. 11 is a schematic cross-sectional diagram in which a working head of the additive manufacturing apparatus illustrated in FIG. 1 moves to the next process area.

FIG. 12 is a schematic cross-sectional diagram for explaining a method of creating an object with the additive manufacturing apparatus illustrated in FIG. 1.

FIG. 13 is a schematic diagram for explaining the order in which dot beads are formed by the additive manufacturing apparatus illustrated in FIG. 1.

FIG. 14 is a flowchart for explaining the operation of the additive manufacturing apparatus according to a second embodiment of the present invention.

FIG. 15 is a schematic cross-sectional diagram illustrating the position of the central axis of the laser beam, with the working head of the additive manufacturing apparatus illustrated in FIG. 1 moved to a second position.

FIG. 16 is a schematic cross-sectional diagram in which the wire is discharged to a position where the end of the wire intersects the central axis of the laser beam in the additive manufacturing apparatus illustrated in FIG. 1.

FIG. 17 is a schematic cross-sectional diagram in which the end of the wire of the additive manufacturing apparatus illustrated in FIG. 1 is in contact with the additive target surface.

FIG. 18 is a schematic cross-sectional diagram in which the working head of the additive manufacturing apparatus illustrated in FIG. 1 moves to the next process area.

FIG. 19 is a schematic cross-sectional diagram in which a fourth dot bead layer is formed by the additive manufacturing apparatus illustrated in FIG. 1.

FIG. 20 is a flowchart for explaining the operation of the additive manufacturing apparatus illustrated in FIG. 1 according to a third embodiment.

FIG. 21 is a schematic cross-sectional diagram illustrating the position of the central axis of the laser beam, with the working head of the additive manufacturing apparatus illustrated in FIG. 1 moved to a first position.

FIG. 22 is a schematic cross-sectional diagram in which the wire is discharged to a standby position in the additive manufacturing apparatus illustrated in FIG. 1.

FIG. 23 is a schematic cross-sectional diagram in which the irradiation of the process area with the laser beam is started in the additive manufacturing apparatus illustrated in FIG. 1.

FIG. 24 is a schematic cross-sectional diagram in which the supply of the wire to the process area of the additive manufacturing apparatus illustrated in FIG. 1 is started.

FIG. 25 is a schematic diagram for explaining a method of calculating the end position of the wire according to the third embodiment of the present invention.

FIG. 26 is a list of conditions for explaining the method of calculating the end position of the wire according to the third embodiment of the present invention.

FIG. 27 is a flowchart for explaining the operation of the additive manufacturing apparatus illustrated in FIG. 1 according to a fourth embodiment.

FIG. 28 is a schematic cross-sectional diagram in which the wire of the additive manufacturing apparatus illustrated in FIG. 1 moves upward.

FIG. 29 is a schematic cross-sectional diagram in which the wire is pulled out from the process area of the additive manufacturing apparatus illustrated in FIG. 1.

FIG. 30 is a diagram illustrating an example of the relationship between the moving direction of the working head and the supply direction of the wire according to a fifth embodiment of the present invention.

FIG. 31 is a flowchart for explaining the operation of the additive manufacturing apparatus illustrated in FIG. 1 according to a sixth embodiment.

FIG. 32 is a schematic cross-sectional diagram illustrating the position of the central axis of the laser beam, with the working head of the additive manufacturing apparatus illustrated in FIG. 1 moved to the first position.

FIG. 33 is a schematic cross-sectional diagram in which the end of the wire discharged to the process area is in contact with the additive target surface in the additive manufacturing apparatus illustrated in FIG. 1.

FIG. 34 is a schematic cross-sectional diagram in which the supply of the wire to the process area of the additive manufacturing apparatus illustrated in FIG. 1 is started.

FIG. 35 is a schematic cross-sectional diagram in which the irradiation of the process area with the laser beam is started in the additive manufacturing apparatus illustrated in FIG. 1.

FIG. 36 is a schematic cross-sectional diagram in which a molten wire is welded to the additive target surface in the additive manufacturing apparatus illustrated in FIG. 1.

FIG. 37 is a flowchart for explaining another example of the operation of the additive manufacturing apparatus illustrated in FIG. 1 according to the sixth embodiment.

FIG. 38 is a schematic cross-sectional diagram illustrating the position of the central axis of the laser beam, with the working head of the additive manufacturing apparatus illustrated in FIG. 1 moved to the first position.

FIG. 39 is a schematic cross-sectional diagram in which the wire is discharged to a position where the end of the wire is not in contact with the additive target surface in the additive manufacturing apparatus illustrated in FIG. 1.

FIG. 40 is a schematic cross-sectional diagram in which the supply of the wire to the process area of the additive manufacturing apparatus illustrated in FIG. 1 is started.

FIG. 41 is a schematic cross-sectional diagram in which the irradiation of the process area with the laser beam is started in the additive manufacturing apparatus illustrated in FIG. 1.

FIG. 42 is a schematic cross-sectional diagram in which the molten wire is welded to the additive target surface in the additive manufacturing apparatus illustrated in FIG. 1.

FIG. 43 is a diagram in which a measurement system is provided in the additive manufacturing apparatus illustrated in FIG. 1.

FIG. 44 is a flowchart for explaining the operation of the additive manufacturing apparatus illustrated in FIG. 1 according to a seventh embodiment.

FIG. 45 is a schematic cross-sectional diagram illustrating the position of the central axis of the laser beam, with the working head of the additive manufacturing apparatus illustrated in FIG. 1 moved to the first position.

FIG. 46 is a schematic cross-sectional diagram in which the wire is discharged to a position where the end of the wire is not in contact with the process area in the additive manufacturing apparatus illustrated in FIG. 1.

FIG. 47 is a schematic cross-sectional diagram in which the irradiation of the process area with the laser beam is started in the additive manufacturing apparatus illustrated in FIG. 1.

FIG. 48 is a schematic cross-sectional diagram in which the supply of the wire to the process area of the additive manufacturing apparatus illustrated in FIG. 1 is started.

FIG. 49 is a diagram illustrating an image of the wire supplied at an excessive supply speed in additive working by the additive manufacturing apparatus illustrated in FIG. 1.

FIG. 50 is a diagram illustrating an image of the wire supplied at a normal supply speed in additive working by the additive manufacturing apparatus illustrated in FIG. 1.

### DESCRIPTION OF EMBODIMENTS

Hereinafter, an additive manufacturing apparatus and an additive manufacturing method according to embodiments of the present invention will be described in detail based on the drawings. The present invention is not limited to the embodiments.

### First Embodiment

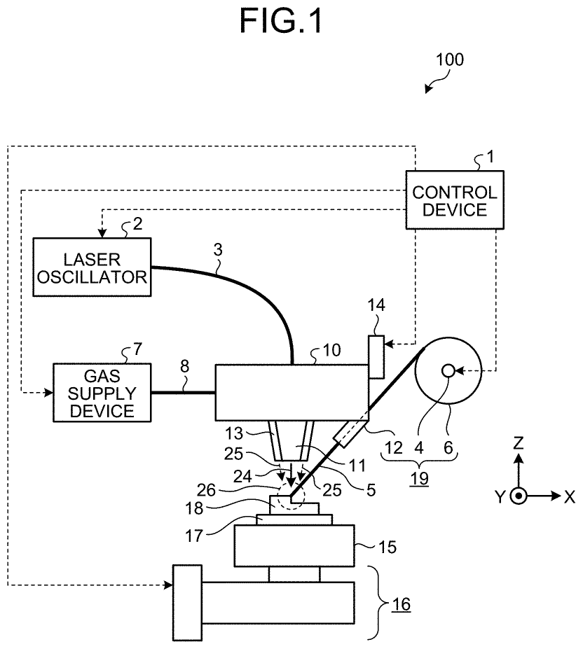

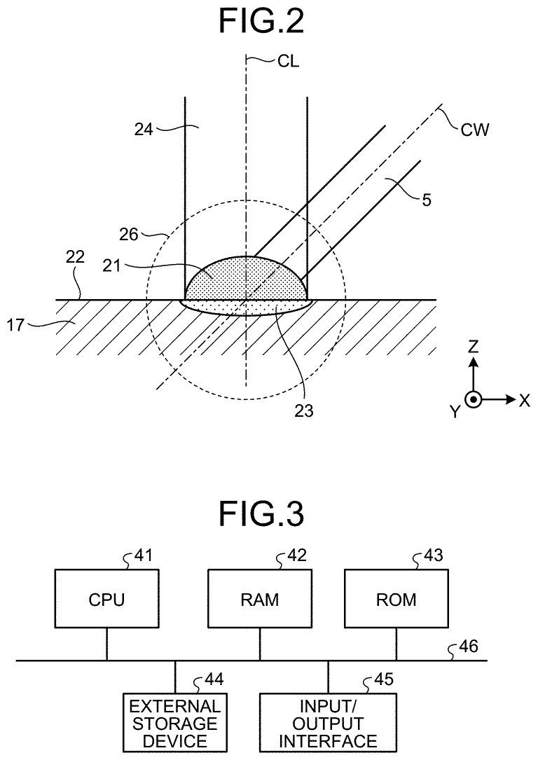

FIG. 1 is a diagram illustrating an additive manufacturing apparatus 100 according to the first embodiment of the present invention. FIG. 2 is a schematic diagram for explaining a process area 26 according to the first embodiment of the present invention. The additive manufacturing apparatus 100 creates a three-dimensional object by additive working, in which a material melted by being irradiated with a beam is added to an additive target surface of a workpiece. In the first embodiment, the beam is a laser beam 24, and the material is a wire-shaped build material, specifically, a wire 5 made of metal. Note that the wire-shaped build material may be a material other than metal.

The additive manufacturing apparatus 100 forms a metallic deposit 18 on a surface of a base material 17 by depositing a bead on the base material 17. A bead is a body, or the deposit 18, formed by solidification of the wire 5 melted. In the first embodiment, dot-shaped beads are formed as beads. Hereinafter, dot-shaped beads are referred to as dot beads. That is, the melted wire 5 is solidified into the dot beads that are the dot-shaped metal. The base material 17 is placed on a stage 15. The workpiece refers to the base material 17 or the deposit 18. The object refers to the deposit 18 having material added in accordance with a working program. The base material 17 illustrated in FIG. 1 is a plate material. The base material 17 may be a material other than a plate material.

The additive manufacturing apparatus 100 includes a working head 10 including a beam nozzle 11, a wire nozzle 12, and a gas nozzle 13. The beam nozzle 11 emits the laser beam 24 toward the workpiece. The laser beam 24 is a heat source for melting the material. The wire nozzle 12 advances the wire 5 toward the radiation position of the laser beam 24 on the workpiece.

The gas nozzle 13 ejects, toward the workpiece, a shield gas for preventing oxidation of the deposit 18 and cooling dot beads. In the first embodiment, the shield gas is an inert gas 25. The beam nozzle 11, the wire nozzle 12, and the gas nozzle 13 are fixed to the working head 10 so that their positional relationship is uniquely determined. That is, the relative positional relationship between the beam nozzle 11, the gas nozzle 13, and the wire nozzle 12 is fixed by the working head 10.

A laser oscillator 2 oscillates the laser beam 24. The laser beam 24 from the laser oscillator 2, which is a beam source, propagates to the working head 10 through a fiber cable 3, which is an optical transmission line. The laser oscillator 2, the fiber cable 3, and the working head 10 define an irradiation unit that irradiates the workpiece with the laser beam 24 that melts the wire 5. The laser beam 24 that is radiated from the beam nozzle 11 onto the workpiece and the central axis CW of the wire 5 may be non-coaxial or coaxial. The laser beam 24 that is radiated from the beam nozzle 11 onto the workpiece and the central axis CW of the wire 5 can be coaxially arranged by using a donut-shaped donut beam as the laser beam 24 or by using a plurality of branched laser beams as the laser beam 24. Note that the first embodiment gives a case where the laser beam 24 that is radiated from the beam nozzle 11 onto the workpiece and the central axis CW of the wire 5 are non-coaxial. A gas supply device 7 supplies gas to the gas nozzle 13 through a pipe 8. The gas supply device 7, the pipe 8, and the gas nozzle 13 define a gas supply unit that ejects the inert gas 25 to the process area 26.

A wire spool 6 around which the wire 5 is wound is a source of material. A rotary motor 4, which is a servomotor, is driven to rotate the wire spool 6, and the wire 5 is accordingly unwound from the wire spool 6. The wire 5 unwound from the wire spool 6 is supplied to the radiation position of the laser beam 24 through the wire nozzle 12. Reverse rotation of the rotary motor 4 in the direction opposite to the direction of unwinding the wire 5 from the wire spool 6 enables the wire 5 supplied to the radiation position of the laser beam 24 to be pulled out from the radiation position of the laser beam 24. In this case, a part, close to the wire spool 6, of the wire 5 unwound from the wire spool 6 is wound around the wire spool 6. The rotary motor 4, the wire spool 6, and the wire nozzle 12 define a wire supply unit 19.

Note that the wire nozzle 12 may include an operating mechanism for pulling out the wire 5 from the wire spool 6. The additive manufacturing apparatus 100 includes at least one of the rotary motor 4 of the wire spool 6 and the operating mechanism of the wire nozzle 12, so that the wire 5 can be supplied to the radiation position of the laser beam 24. In FIG. 1, the operating mechanism of the wire nozzle 12 is not illustrated.

A head drive device 14 moves the working head 10 in each of the X-axis direction, the Y-axis direction, and the Z-axis direction. The X, Y, and Z axes are three axes perpendicular to one another. The X and Y axes are horizontally parallel axes. The Z-axis direction is the vertical direction. The head drive device 14 includes a servomotor that provides an operating mechanism for moving the working head 10 in the X-axis direction, a servomotor that provides an operating mechanism for moving the working head 10 in the Y-axis direction, and a servomotor that provides an operating mechanism for moving the working head 10 in the Z-axis direction. The head drive device 14 is an operating mechanism that enables the working head 10 to undergo translational movement in each direction of the three axes. In FIG. 1, the servomotors are not illustrated. For the additive manufacturing apparatus 100, the head drive device 14 moves the working head 10 to thereby move the radiation position of the laser beam 24 on the workpiece. For the additive manufacturing apparatus 100, the stage 15 may move to thereby move the radiation position of the laser beam 24 on the workpiece.

The working head 10 illustrated in FIG. 1 advances the laser beam 24 from the beam nozzle 11 in the Z-axis direction. The wire nozzle 12 is provided at a position away from the beam nozzle 11 on an XY plane, and advances the wire 5 in a direction oblique to the Z axis. Note that the wire nozzle 12 may be fixed to the working head 10 in a different direction so as to advance the wire 5 in a direction parallel to the Z axis. The wire nozzle 12 is used to limit the advancement of the wire 5 such that the wire 5 is supplied to a desired position.

On the working head 10 illustrated in FIG. 1, the gas nozzle 13 is provided coaxially with the beam nozzle 11 on the outer peripheral side of the beam nozzle 11 on an X-Y plane, and ejects gas along the central axis of the laser beam 24 that is emitted from the beam nozzle 11. That is, the beam nozzle 11 and the gas nozzle 13 are disposed coaxially with each other. Note that the gas nozzle 13 may eject gas in a direction oblique to the Z axis. That is, the gas nozzle 13 may eject gas in a direction oblique to the central axis of the laser beam 24 that is emitted from the beam nozzle 11.

A rotation mechanism 16 is an operating mechanism that enables the stage 15 to rotate on a first axis and enables the stage 15 to rotate on a second axis perpendicular to the first axis. In the rotation mechanism 16 illustrated in FIG. 1, the first axis is an axis parallel to the X axis, and the second axis is an axis parallel to the Y axis. The rotation mechanism 16 includes a servomotor that provides an operating mechanism for rotating the stage 15 on the first axis, and a servomotor that provides an operating mechanism for rotating the stage 15 on the second axis. The rotation mechanism 16 is an operating mechanism that enables the stage 15 to undergo rotational movement on each of the two axes. In FIG. 1, the servomotors are not illustrated. The additive manufacturing apparatus 100 can change the posture or position of the workpiece by rotating the stage 15 using the rotation mechanism 16. That is, the additive manufacturing apparatus 100 can move the radiation position of the laser beam 24 on the workpiece by rotating the stage 15. The use of the rotation mechanism 16 makes it possible to create a complicated shape having a tapered shape.

A control device 1 controls the additive manufacturing apparatus 100 according to a working program. The control device 1, which controls the supply unit, the irradiation unit, and the gas supply unit, is in charge of control for creating an object 101 with a plurality of dot beads 32 formed of the wire 5 melted. The control device 1 is, for example, a numerical control device. The control device 1 outputs a movement command to the head drive device 14 to drive and control the head drive device 14 to move the working head 10. The control device 1 outputs a command to the laser oscillator 2 in accordance with the conditions of beam output to control laser oscillation of the laser oscillator 2.

The control device 1 outputs a command to the rotary motor 4 in accordance with the conditions of the amount of material supply to drive and control the rotary motor 4. By driving and controlling the rotary motor 4, the control device 1 adjusts the speed of the wire 5 running from the wire spool 6 to the radiation position. In the following description, this speed may be referred to as the supply speed. The supply speed represents the amount of material supplied per hour.

The control device 1 controls the amount of supply of the inert gas 25 from the gas supply device 7 to the gas nozzle 13 by outputting a command to the gas supply device 7 in accordance with the conditions of the amount of gas supply. The control device 1 drives and controls the rotation mechanism 16 by outputting a rotation command to the rotation mechanism 16. That is, the control device 1 controls the entirety of the additive manufacturing apparatus 100 by outputting various commands.

The object 101 is formed by depositing a molten wire 21 in the process area 26 using the laser beam 24 that is radiated from the beam nozzle 11. As illustrated in FIG. 2, in the process area 26 is supplied with the wire 5, and the wire 5 is irradiated with the laser beam 24. In the process area 26, an additive target surface 22 consisting of a surface of the base material 17 or a surface of the deposit 18 melts into a molten pool 23. Then, in the process area 26, the molten wire 21 generated by melting of the wire 5 is welded to the molten pool 23. The additive target surface 22 is a working target surface for additive working that welds the molten wire 21 to the additive target surface 22 to form the deposit 18 thereon. The process area 26 is an area within which the additive working is performed on the additive target surface 22.

The head drive device 14 and the rotation mechanism 16 are operated in conjunction with each other to move the working head 10 and the stage 15, whereby the position of the process area 26 can be changed, and the object 101 having a desired shape can be obtained.

The hardware configuration of the control device 1 will be described. The control device 1 illustrated in FIG. 1 is implemented by hardware executing a control program, which is a program for executing the control of the additive manufacturing apparatus 100 according to the first embodiment.

FIG. 3 is a block diagram illustrating the hardware configuration of the control device 1 according to the first embodiment of the present embodiment. The control device 1 includes a central processing unit (CPU) 41 that executes various processes, a random access memory (RAM) 42 that includes a data storage area, a read only memory (ROM) 43 that is a non-volatile memory, an external storage device 44, and an input/output interface 45 for inputting information to the control device 1 and outputting information from the control device 1. The components illustrated in FIG. 3 are connected to one another via a bus 46.

The CPU 41 executes programs stored in the ROM 43 and the external storage device 44. The entire control of the additive manufacturing apparatus 100 by the control device 1 is implemented using the CPU 41.

The external storage device 44 is a hard disk drive (HDD) or a solid state drive (SSD). The external storage device 44 stores the control program and various data. The ROM 43 stores software or a program for controlling hardware, specifically, a boot loader such as a basic input/output system (BIOS) or a unified extensible firmware interface (UEFI), which is a program for basic control of a computer or controller serving as the control device 1. Note that the control program may be stored in the ROM 43.

Programs stored in the ROM 43 and the external storage device 44 are loaded into the RAM 42. The CPU 41 develops the control program in the RAM 42 and executes various processes. The input/output interface 45 is an interface for connection with a device external to the control device 1. A working program is input to the input/output interface 45. The input/output interface 45 outputs various commands. The control device 1 may include an input device such as a keyboard and a pointing device, and an output device such as a display.

The control program may be stored in a storage medium readable by a computer. The control device 1 may store the control program stored in the storage medium in the external storage device 44. The storage medium may be a portable storage medium which is a flexible disk or a flash memory which is a semiconductor memory. The control program may be installed from another computer or a server device to a computer or controller serving as the control device 1 via a communication network.

The functions of the control device 1 may be implemented by processing circuitry which is dedicated hardware for controlling the additive manufacturing apparatus 100. The processing circuitry is a single circuit, a composite circuit, a programmed processor, a parallel programmed processor, an application specific integrated circuit (ASIC), a field-programmable gate array (FPGA), or a combination thereof. Note that some of the functions of the control device 1 may be implemented by dedicated hardware, and the other functions may be implemented by software or firmware.

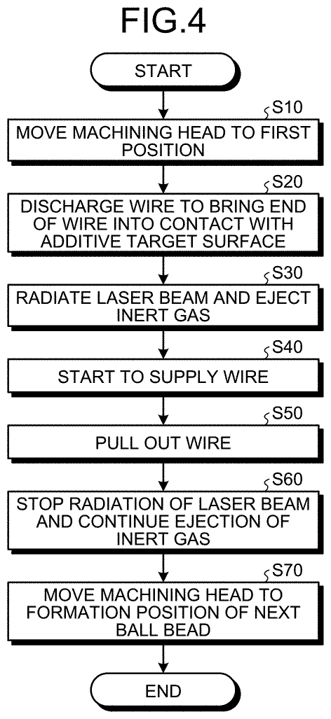

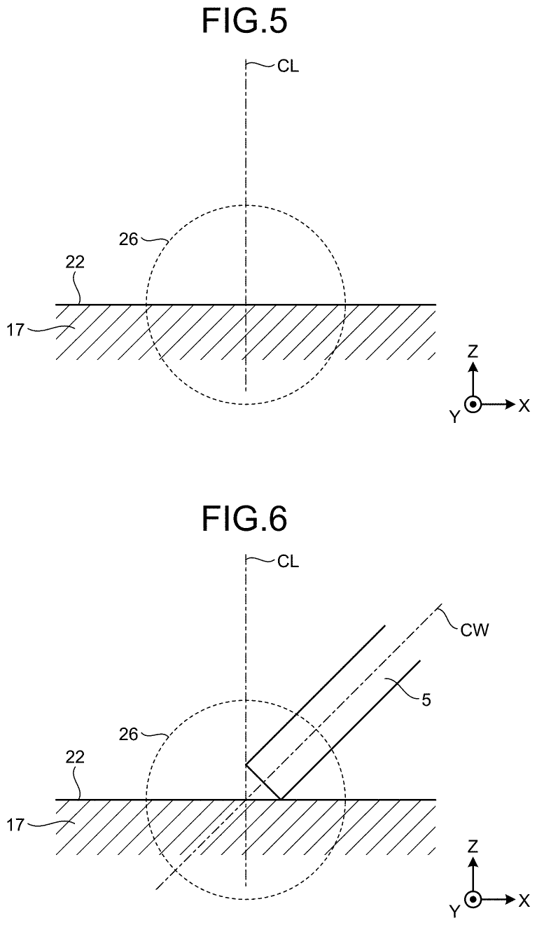

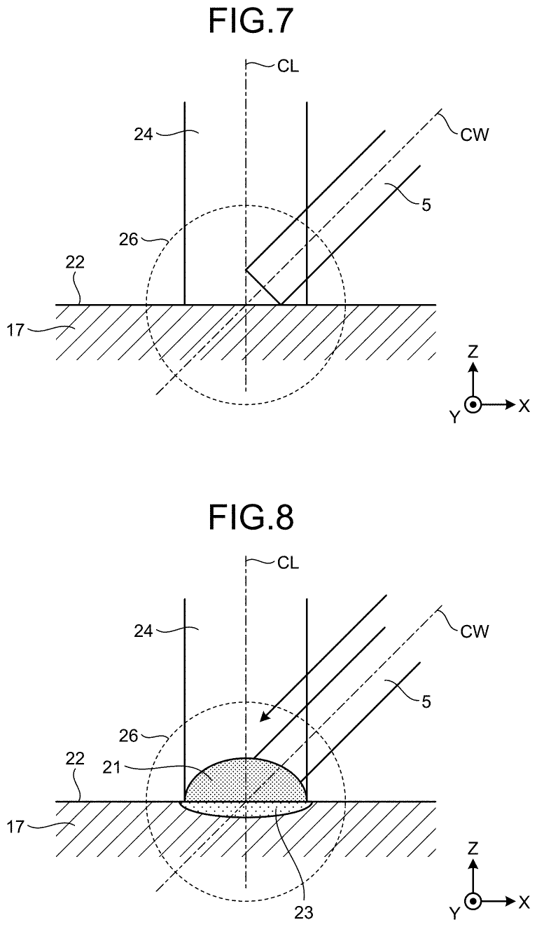

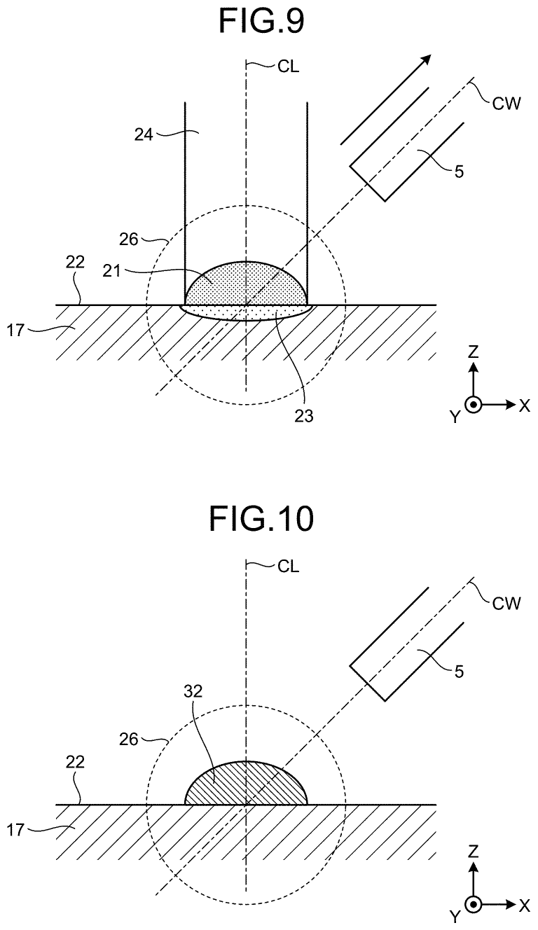

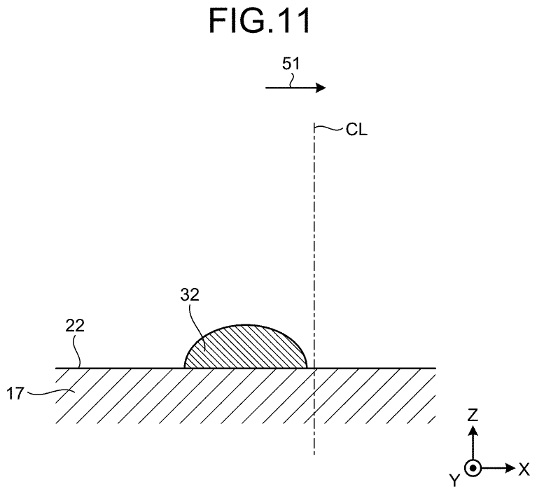

Next, the operation of the additive manufacturing apparatus 100 according to the first embodiment will be described with reference to FIGS. 4 to 11. FIG. 4 is a flowchart for explaining the operation of the additive manufacturing apparatus 100 according to the first embodiment of the present invention. FIG. 5 is a schematic cross-sectional diagram illustrating the process area 26 of the additive manufacturing apparatus 100 illustrated in FIG. 1. FIG. 6 is a schematic cross-sectional diagram in which the end of the wire 5 discharged to the process area 26 of the additive manufacturing apparatus 100 illustrated in FIG. 1 is in contact with the additive target surface 22. FIG. 7 is a schematic cross-sectional diagram in which the process area 26 of the additive manufacturing apparatus 100 illustrated in FIG. 1 is irradiated with the laser beam 24. FIG. 8 is a schematic cross-sectional diagram in which the supply of the wire 5 to the process area 26 of the additive manufacturing apparatus 100 illustrated in FIG. 1 is started. FIG. 9 is a schematic cross-sectional diagram in which the wire 5 is pulled out from the process area 26 of the additive manufacturing apparatus 100 illustrated in FIG. 1. FIG. 10 is a schematic cross-sectional diagram in which the irradiation of the process area 26 of the additive manufacturing apparatus 100 illustrated in FIG. 1 with the laser beam 24 is stopped. FIG. 11 is a schematic cross-sectional diagram in which the working head 10 of the additive manufacturing apparatus 100 illustrated in FIG. 1 moves to the next process area 26. FIGS. 5 to 11 illustrate the state of a peripheral region of the process area 26 on the additive target surface 22. Note that the inert gas 25 is not illustrated in FIGS. 7 to 10.

First, in step S10, the working head 10 moves to and stops at a predetermined first position above the process area 26 on the additive target surface 22 of the base material 17. Here, the additive target surface 22 is the surface of the base material 17, specifically, the upper surface of the base material 17 placed on the stage 15. On the additive target surface 22, the dot bead 32 is to be deposited. As illustrated in FIG. 5, the working head 10 moves to the first position where the central axis CL of the laser beam 24 emitted from the beam nozzle 11 is located at the central position of the process area 26 on the additive target surface 22.

Next, in step S20, as illustrated in FIG. 6, the wire nozzle 12 discharges the wire 5 obliquely from above the process area 26 toward the process area 26 on the additive target surface 22, and brings the end of the wire 5 into contact with the additive target surface 22. That is, in the first embodiment, the end of the wire 5 is brought into contact with the additive target surface 22 before the process area 26 on the additive target surface 22 is irradiated with the laser beam 24. To discharge the wire 5 means that the wire 5 advances out of the wire nozzle 12 and is supplied toward the radiation position of the laser beam 24 in the process area 26 on the additive target surface 22.

At this time, it is preferable that the central axis CW of the wire 5 discharged from the wire nozzle 12 and brought into contact with the additive target surface 22, and the central axis CL of the laser beam 24 radiated onto the process area 26 intersect at the surface of the additive target surface 22, or the central axis CW of the wire 5 intersect the surface of the additive target surface 22 within the beam radius of the laser beam 24 between the wire nozzle 12 and the central axis CL of the laser beam 24 radiated onto the process area 26. This enables the dot bead 32 to be formed on the additive target surface 22 such that the formed dot bead 32 has its center on the intersection of the central axis CW of the wire 5 and the central axis CL of the laser beam 24 radiated onto the process area 26.

Next, in step S30, as illustrated in FIG. 7, the laser beam 24 is radiated toward the process area 26 on the additive target surface 22, such that the wire 5 placed in the process area 26 on the additive target surface 22 is irradiated with the laser beam 24. In conjunction with the radiation of the laser beam 24, the ejection of the inert gas 25 from the gas nozzle 13 to the process area 26 is started. In this case, it is preferable that the inert gas 25 be ejected from the gas nozzle 13 for a predetermined fixed time before the additive target surface 22 is irradiated with the laser beam 24. This enables the active gas such as oxygen remaining in the gas nozzle 13 to be removed from the gas nozzle 13.

Next, in step S40, the wire nozzle 12 starts to supply the wire 5 to the process area 26 as illustrated in FIG. 8. That is, the wire nozzle 12 further discharges the wire 5 toward the additive target surface 22. As a result, a part of the wire 5 placed in advance in the process area 26 and a part of the wire 5 supplied to the process area 26 after the start of the radiation of the laser beam 24 melt to form the molten wire 21, such that the molten wire 21 is welded to the additive target surface 22. Consequently, the dot bead 32, which is the deposit 18, is formed in the process area 26 on the additive target surface 22. After that, the supply of the wire 5 to the process area 26 is continued for a predetermined supply time.

The supply speed of the wire 5 can be adjusted by the rotation speed of the rotary motor 4. The supply speed of the wire 5 is limited by the output of the laser beam 24. That is, there is a correlation between the supply speed of the wire 5 and the output of the laser beam 24 for achieving proper welding of the molten wire 21 to the process area 26. It is possible to increase the formation speed of the dot bead 32 by increasing the output of the laser beam 24.

If the supply speed of the wire 5 is too fast relative to the output of the laser beam 24, the wire 5 remains unmelted. If the supply speed of the wire 5 is slow relative to the output of the laser beam 24, the wire 5 is overheated, and thus the molten wire 21 falls from the wire 5 in the form of droplets without being welded into a desired shape.

The size of the dot bead 32 can be adjusted by changing the supply time of the wire 5 and the radiation time of the laser beam 24. Increasing the supply time of the wire 5 and the radiation time of the laser beam 24 makes it possible to form the dot bead 32 having a large diameter. In contrast, shortening the supply time of the wire 5 and the radiation time of the laser beam 24 makes it possible to form the dot bead 32 having a small diameter.

Next, in step S50, as illustrated in FIG. 9, the wire 5 is pulled out from the process area 26.

Next, in step S60, as illustrated in FIG. 10, the laser oscillator 2 is stopped to stop the irradiation of the process area 26 with the laser beam 24. Here, the gas nozzle 13 does not stop but continues ejecting the inert gas 25 toward the workpiece. That is, after the laser oscillator 2 is stopped, the gas nozzle 13 continues ejecting the inert gas 25 toward the process area 26 for a predetermined duration.

The duration is the period of time for which the ejection of the inert gas 25 from the gas nozzle 13 toward the workpiece is continued after the laser oscillator 2 is stopped until the temperature of the dot bead 32 welded to the process area 26 decreases to a predetermined temperature. The duration is determined based on various conditions such as the material of the wire 5 and the size of the dot bead 32, and is stored in the control device 1 in advance. Then, once the predetermined duration elapses after the laser oscillator 2 is stopped, the ejection of the inert gas 25 from the gas nozzle 13 to the process area 26 is stopped, and the formation of one dot bead 32 is completed.

Then, in step S70, as illustrated in FIG. 11, the working head 10 moves toward the position for the next dot bead 32 to be formed on the additive target surface 22 of the base material 17. The arrow 51 in FIG. 11 indicates the moving direction of the working head 10.

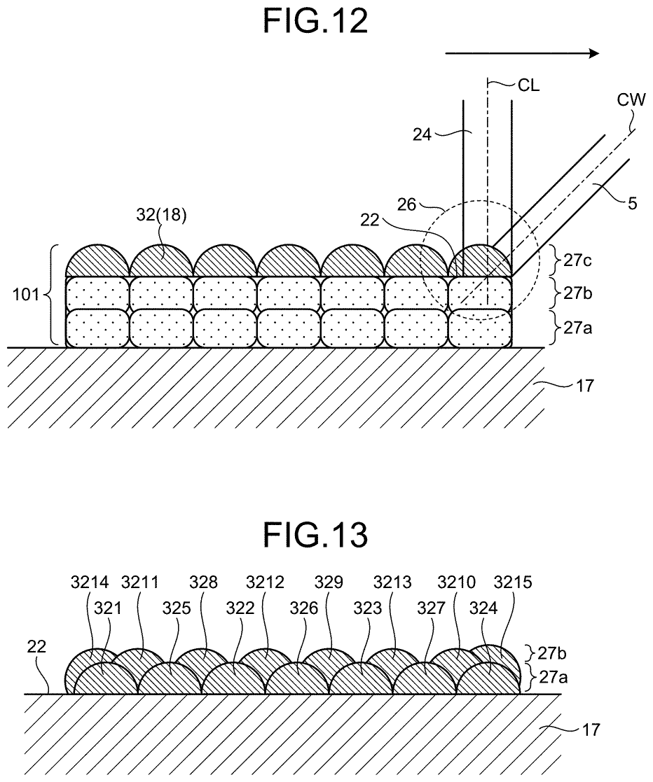

FIG. 12 is a schematic cross-sectional diagram for explaining a method of creating the object 101 with the additive manufacturing apparatus 100 illustrated in FIG. 1. Repeating the above-mentioned steps makes it possible to form a first dot bead layer 27a on the additive target surface 22. The first dot bead layer 27a is a layer of dot beads 32 that provide the object 101. Then, as illustrated in FIG. 12, repeating the above-mentioned steps on the first dot bead layer 27a results in a second dot bead layer 27b thereon, followed by a third dot bead layer 27c and subsequent dot bead layers overlayed on one another, such that a plurality of dot bead layers are laminated together to thereby form the object 101 having a desired shape. In the additive working for forming the dot beads of the second and subsequent layers, the additive target surface 22 is the upper surface of the dot bead layer that has been already formed.

As described above, because the additive manufacturing apparatus 100 according to the first embodiment uses the laser beam 24 as a heat source for melting the wire 5, the heat source input time required for melting the wire 5 and separating the molten wire 21 from the wire 5 can be shortened. As a result, the additive manufacturing apparatus 100 can form the reduced-size dot bead 32, so that the shape accuracy of the object 101 can be improved. The heat source input time is the period of time for which the wire 5 is irradiated with the laser beam 24.

Because the additive manufacturing apparatus 100 according to the first embodiment brings the end of the wire 5 into contact with the additive target surface 22 before the wire 5 is irradiated with the laser beam 24, the molten wire 21 is stably welded to the additive target surface 22, thereby preventing the molten wire 21 from failing to be welded to the additive target surface 22.

Immediately after the radiation of the laser beam 24 is started, an area of the additive target surface 22 below the end portion of the wire 5 is not irradiated with the laser beam 24. Therefore, the temperature of the additive target surface 22 located below the end portion of the wire 5 is lower than that of the upper portion, irradiated with the laser beam 24, of the molten wire 21 that is the melted end portion of the wire 5. In addition, the temperature of the upper portion of the molten wire 21 that is the melted end portion of the wire 5 is relatively higher than that of the lower portion of the molten wire 21 that is the melted end portion of the wire 5.

Therefore, if the wire 5 is not in contact with the additive target surface 22 before the wire 5 is irradiated with the laser beam 24, a “run-up phenomenon” occurs immediately after the irradiation of the wire 5 with the laser beam 24 is started. The “run-up phenomenon” is a phenomenon where the lower portion of the molten wire 21 is not separated from the unmelted portion of the wire 5, but is attracted to the upper portion of the molten wire 21 having a relatively high temperature. The occurrenace of such a run-up phenomenon makes it likely that the molten wire 21 fails to be welded to the additive target surface 22. This is because the wettability of the upper portion of the molten wire 21 increases.

The molten wire 21 attracted to the upper portion having a high temperature without being separated from the unmelted portion of the wire 5 is eventually separated from the unmelted portion of the wire 5 and drops on the additive target surface 22. In this case, unfortunately, the dot bead 32 may not be formed at a desired position, which leads to a deterioration in the shape accuracy of the object 101.

Because the additive manufacturing apparatus 100 brings the end of the wire 5 into contact with the additive target surface 22 before the wire 5 is irradiated with the laser beam 24, it is possible to prevent the above-described run-up phenomenon from occurring immediately after the irradiation of the wire 5 with the laser beam 24 is started, thereby preventing the molten wire 21 from failing to be welded to the additive target surface 22. As a result, the additive manufacturing apparatus 100 can reliably weld the wire 5 to the additive target surface 22, and can manufacture the object 101 with high shape accuracy. In the above-described case, the laser beam 24 radiated from the beam nozzle 11 onto the workpiece, and the central axis CW of the wire 5 are non-coaxial. That is, in the above-described case, the wire 5 is discharged obliquely from above the process area 26 toward the process area 26 on the additive target surface 22. The laser beam 24 radiated from the beam nozzle 11 onto the workpiece, and the central axis CW of the wire 5 may be coaxial, in which case an effect similar to the above-mentioned effect can be obtained by bringing the end of the wire 5 into contact with the additive target surface 22 before the wire 5 is irradiated with the laser beam 24.

In the case of forming the object 101 by repeatedly depositing the dot beads 32, the number of times that the molten wire 21 is welded is equal to the number of dot beads 32. Therefore, to prevent the failure to be welded to the additive target surface 22 is highly effective in improving the shape accuracy of the object 101.

In step S20 described above, the central axis CW of the wire 5 discharged from the wire nozzle 12 and brought into contact with the additive target surface 22 and the central axis CL of the laser beam 24 radiated onto the process area 26 may not intersect at the surface of the additive target surface 22. In this case, as long as the wire 5 is irradiated with the laser beam 24, the wire 5 is melted to be spread and welded to the area of the additive target surface 22 irradiated with the laser beam 24.

If the central axis CW has a point located on the additive target surface 22 more closely to the wire nozzle 12 away from the point of the central axis CL on the additive target surface 22 when the wire 5 contacts the additive target surface 22 with the laser beam 24 being radiated onto the process area 26, the wire 5 is more difficult to melt. If the central axis CW has a point located on the additive target surface 22 farther from the wire nozzle 12 away from the point of the central axis CL on the additive target surface 22 when the wire 5 contacts the additive target surface 22 with the laser beam 24 being radiated onto the process area 26, the wire 5 is easiler to melt excessively.

In the additive manufacturing apparatus 100, the position of the working head 10 is fixed without being moved during welding of the wire 5 to the additive target surface 22. That is, the process area 26 is irradiated with the laser beam 24 for a predetermined radiation time while the wire 5 is supplied from a fixed position to the process area 26. After the radiation of the laser beam to the process area 26 for the predetermined radivation time, the radiation of the laser beam 24 and the supply of the wire 5 are stopped. This is effective in forming a plurality of dot beads 32 because, regardless of the path along which to form the plurality of dot beads 32, the dot beads 32 can be formed in uniform shapes on the additive target surface 22 to thereby improve the accuracy of the shape of the object 101.

In the additive manufacturing apparatus 100, after the laser oscillator 2 is stopped, the working head 10 does not immediately move toward the next process area 26, but the ejection of the inert gas 25 toward the process area 26 is continued for the predetermined duration. That is, in the additive manufacturing apparatus 100, the inert gas 25 is ejected to the process area 26 over the period in which the process area 26 is irradiated with the laser beam 24. After the laser oscillator 2 is stopped, the ejection of the inert gas 25 to the dot bead 32, which is the deposit 18 welded to the additive target surface 22, is continued for the duration. As a result, it is possible to prevent oxidation of the dot bead 32 and cool the dot bead 32.

Because the additive manufacturing apparatus 100 deposits the dot beads 32 on top of one another to form the object 101, the degree of freedom of the working path for each of dot bead layers in forming a deposit of layers of dot beads 32 that provide the object 101 is improved. That is, the additive manufacturing apparatus 100 can freely define separate positions at which to form a dot bead 32 in a single layer of dot beads.

FIG. 13 is a schematic diagram for explaining the order in which the dot beads 32 are formed by the additive manufacturing apparatus 100 illustrated in FIG. 1. For example, as illustrated in FIG. 13, a plurality of dot beads 32 can be formed on the additive target surface 22 with a gap between adjacent dot beads 32, and subsequently another dot bead 32 can be formed so as to fill the gap. That is, the control device 1 performs control for forming a plurality of first dot beads with a gap between adjacent dot beads, and subsequently forming a second dot bead in the gap or an area adjacent to the first dot beads.

As illustrated in FIG. 13, a dot bead 321, a dot bead 322, a dot bead 323, and a dot bead 324 are formed in this order with a gap therebetween to thereby form the first dot bead layer 27a. After that, a dot bead 325, a dot bead 326, and a dot bead 327 are formed on the additive target surface 22 in this order so as to fill the gaps between the previously formed dot beads 32.

Then, a dot bead 328, a dot bead 329, a dot bead 3210, a dot bead 3211, a dot bead 3212, a dot bead 3213, a dot bead 3214, and a dot bead 3215 are formed in this order on the first dot bead layer 27a to form the second dot bead layer 27b.

In this case, the dot beads 321, 322, 323, and 324 of the first dot bead layer 27a, which are formed with the gaps, are not in contact with any dot bead 32. That is, the next dot bead 32 is formed at a position away from the dot bead 32 formed immediately before that next dot bead 32. Therefore, each of the dot beads 32 formed with the gaps has a desired size as designed without being affected by the surface tension of the adjacent dot beads 32.

Therefore, the dot bead 321, the dot bead 322, the dot bead 323, and the dot bead 324 have a larger surface area than when the dot beads 32 are formed in contact with one another. As a result, the dot bead formed just now is not directly and thermally connected to the adjacent dot bead 32. It thus becomes possible to disperse heat of each dot bead 32. That is, when the first dot bead layer 27a is formed, heat input can be dispersed over different locations. As a result, the temperature of each dot bead 32 decreases faster than when the dot beads 32 are formed in contact with one another.

The dot beads 325, 326, and 327 of the first dot bead layer 27a, which are formed to fill the gaps, have a higher temperature than each of the dot beads 32 previously formed with the gaps, and therefore, the dot beads 325, 326, and 327 are less affected by the surface tension of the previously formed dot beads 32. The dot beads 32 previously formed with the gaps decrease in temperature to such an extent that there is no difference in temperature between the previously formed dot beads 32 by the time the gap-filling dot beads 32 are formed. As a result, the gap-filling dot beads 32 are not pulled by either of the adjacent dot beads 32. Consequently, each gap-filling dot bead 32 formed along the shape of the adjacent dot beads 32 has its shape adjusted by the surface tension of the gap-filling dot bead 32 itself. That is, the gap-filling dot beads 32 are formed along the adjacent dot beads 32 and thus have improved shape controllability, which leads to an improvement in shape accuracy.

Each gap-filling dot bead 32 in the first dot bead layer 27a is formed without contacting any dot bead 32 in the first dot bead layer 27a. That is, each gap-filling dot bead 32 in the first dot bead layer 27a is formed such that the next dot bead 32 is formed at a position away from the dot bead 32 formed immediately before that next dot bead 32. Similarly, each gap-filling dot bead 32 in the second dot bead layer 27b is formed without contacting any dot bead 32 in the second dot bead layer 27b. That is, each gap-filling dot bead 32 in the second dot bead layer 27b is formed such that the next dot bead 32 is formed at a position away from the dot bead 32 formed immediately before that next dot bead 32. Therefore, each of the dot beads 32 formed with the gaps has a desired size as designed without being affected by the surface tension of the adjacent dot beads 32.

As illustrated in FIG. 13, the second dot bead layer 27b includes the dot bead 3214 and the dot bead 3215 located at the opposite edges thereof. The dot bead 3214 and the dot bead 3215 are formed last in the process of forming the second dot bead layer 27b. The dot bead 3214 is formed in contact with the dot bead 3211. The dot bead 3215 is formed in contact with the dot bead 3210.

In this case, the dot bead 3214 is attracted by the surface tension of the dot bead 3211, thereby preventing distorsion of the shape of the dot bead 3214, that is, preventing deviation of the shape of the dot bead 3214 from the designed shape. That is, the dot bead 3214 has a good shape, utilizing the surface tension of the dot bead 3211. As a result, it is possible to prevent the edge of the second dot bead layer 27b from being distorted in shape.

Similarly, the dot bead 3215 is attracted by the surface tension of the dot bead 3210, thereby preventing distorsion of the shape of the dot bead 3215, that is, preventing deviation of the shape of the dot bead 3215 from the designed shape. That is, the dot bead 3215 has a good shape, utilizing the surface tension of the dot bead 3210. As a result, it is possible to prevent the edge of the second dot bead layer 27b from being distorted in shape.

In forming the third and subsequent dot bead layers, dot beads corresponding to edges of the dot bead layers are formed last, thereby obtaining an effect similar to the above-mentioned effect. As a result, it is possible to prevent the side surfaces and the edge of the top of the object 101 from being distorted in shape.

In the additive manufacturing apparatus 100, after the laser oscillator 2 is stopped, the ejection of the inert gas 25 to the process area 26 is continued until the temperature of the dot bead 32 decreases to a predetermined temperature. This can prevent oxidation of the dot bead 32 and the entire object 101. Because it is possible to form the three-dimensional object 101 while preventing oxidation between the layers of dot beads 32, the mechanical properties of the object 101 can be improved.

Note that the additive manufacturing apparatus 100 can also form a plurality of linearly continuous line beads to form the object 101. In this case, while moving, the gas nozzle 13 forms a single line bead. As a result, the high temperature portion of the line bead is left out of the ejection range of the inert gas 25 before the temperature of the high temperature portion of the line bead decreases. Because an oxidation reaction is likely to occur in the high temperature portion of the bead, the line bead and the entire object are liable to be oxidized.

In the additive manufacturing apparatus 100, the ejection of the inert gas 25 may be stopped during movement of the working head 10, including after the dot bead 32 is formed. That is, the ejection of the inert gas 25 may be stopped after a lapse of the above-mentioned duration until the next radiation of the laser beam 24. As a result, the consumption of the inert gas 25 can be reduced.

As described above, the additive manufacturing apparatus 100 according to the first embodiment can achieve the effect of improving the shape accuracy of the object.

### Second Embodiment

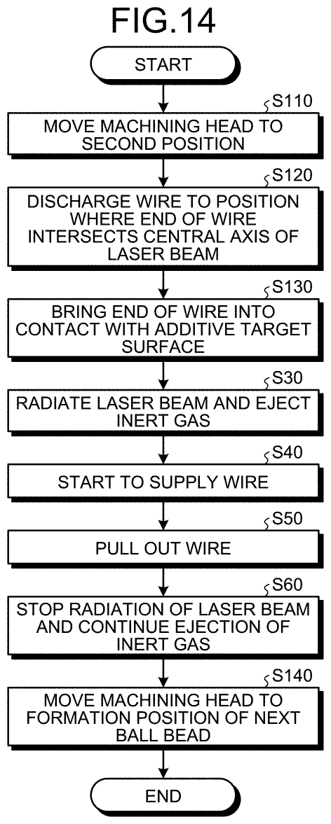

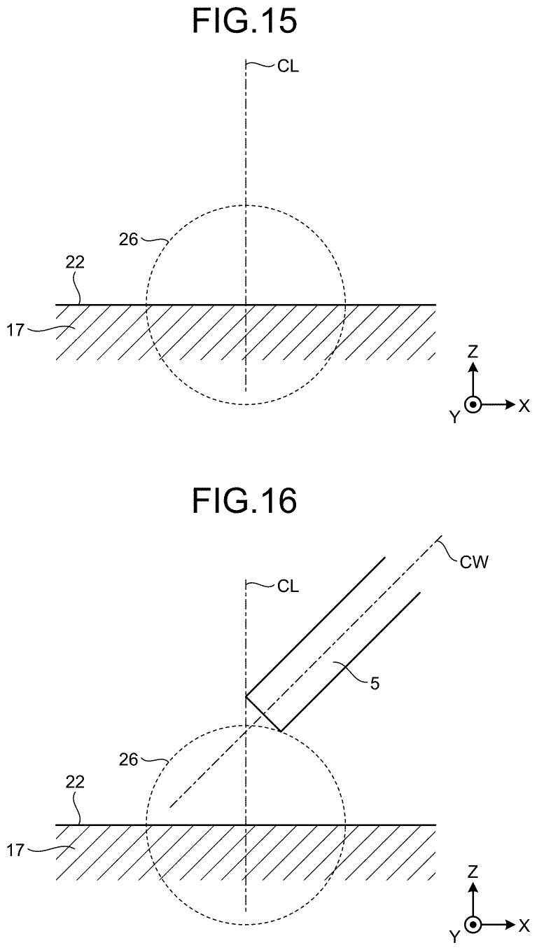

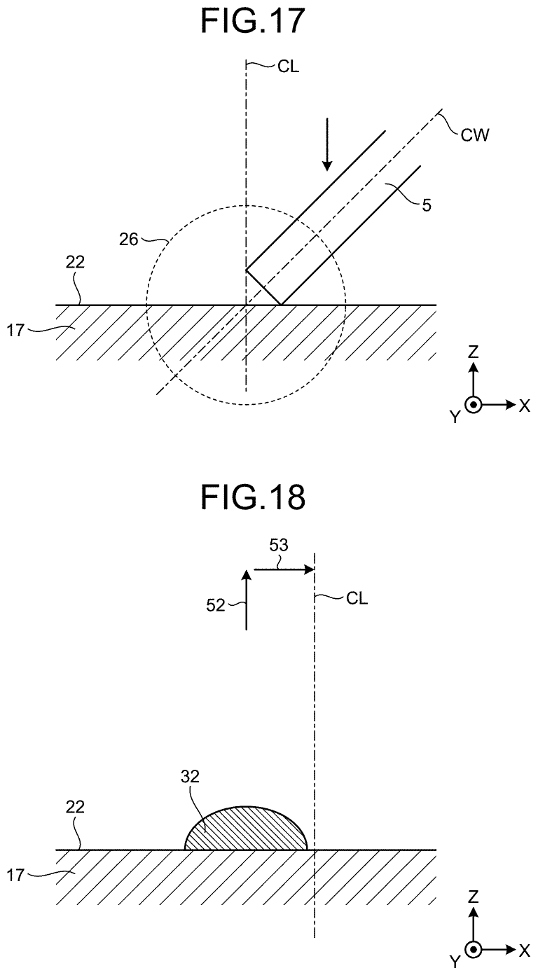

In the second embodiment, another mode of additive working by the additive manufacturing apparatus 100 illustrated in FIG. 1 will be described. Hereinafter, the operation of the additive manufacturing apparatus 100 according to the second embodiment will be described with reference to FIGS. 14 to 18. FIG. 14 is a flowchart for explaining the operation of the additive manufacturing apparatus 100 according to the second embodiment of the present invention. FIG. 15 is a schematic cross-sectional diagram illustrating the position of the central axis CL of the laser beam 24, with the working head 10 of the additive manufacturing apparatus 100 illustrated in FIG. 1 moved to a second position. FIG. 16 is a schematic cross-sectional diagram in which the wire 5 is discharged to a position where the end of the wire 5 intersects the central axis CL of the laser beam 24 in the additive manufacturing apparatus 100 illustrated in FIG. 1. FIG. 17 is a schematic cross-sectional diagram in which the end of the wire 5 of the additive manufacturing apparatus 100 illustrated in FIG. 1 is in contact with the additive target surface 22. FIG. 18 is a schematic cross-sectional diagram in which the working head 10 of the additive manufacturing apparatus 100 illustrated in FIG. 1 moves to the next process area 26. FIGS. 15 to 18 illustrate the state of a peripheral region of the process area 26 on the additive target surface 22.

First, in step S110, the working head 10 moves to and stops at a predetermined second position above the process area 26 on the additive target surface 22 of the base material 17. As illustrated in FIG. 15, the working head 10 moves to the second position where the central axis CL of the laser beam 24 emitted from the beam nozzle 11 is located at the central position of the process area 26 on the additive target surface 22.

In the second embodiment, the working head 10 is placed at a height position where the end of the wire 5 is not in contact with the additive target surface 22 even after the wire 5 is discharged to a position where the central axis CL of the laser beam 24 radiated onto the process area 26 and the wire 5 intersect. That is, the wire nozzle 12 is placed at a height position where the end of the wire 5 is not in contact with the additive target surface 22 even after the wire 5 is discharged to a position where the central axis CL of the laser beam 24 radiated onto the process area 26 and the wire 5 intersect. Therefore, the second position is higher than the first position described above.

That is, in step S110, the working head 10 is placed at a position higher than the height position where the working head 10 is placed in step S10 of the first embodiment. Because the beam nozzle 11, the wire nozzle 12, and the gas nozzle 13 are fixed to the working head 10, in step S110, the beam nozzle 11 and the gas nozzle 13 are also placed at a position higher than in step S10 of the first embodiment.

Next, in step S120, as illustrated in FIG. 16, the wire nozzle 12 discharges the wire 5 toward the process area 26 to reach a position where the end of the wire 5 intersects the central axis CL of the laser beam 24.

Next, in step S130, as illustrated in FIG. 17, the working head 10 is moved downward toward the additive target surface 22 to bring the end of the wire 5 into contact with the additive target surface 22.

Next, in the same manner as in the first embodiment, steps S30 to S60 described above are performed as illustrated in FIGS. 7 to 10.

Then, once the predetermined duration elapses after the laser oscillator 2 is stopped, in step S140, the working head 10 moves toward the formation position of the next dot bead 32 on the additive target surface 22 of the base material 17, as illustrated in FIG. 18. In moving to above the formation position of the next dot bead 32 on the additive target surface 22, the working head 10 moves upward as indicated by the arrow 52 in FIG. 18, and then moves in a direction parallel to the additive target surface 22 as indicated by the arrow 53 in FIG. 18. Note that the working head 10 may move only in an obliquely upward direction in moving to above the formation position of the next dot bead 32 on the additive target surface 22.

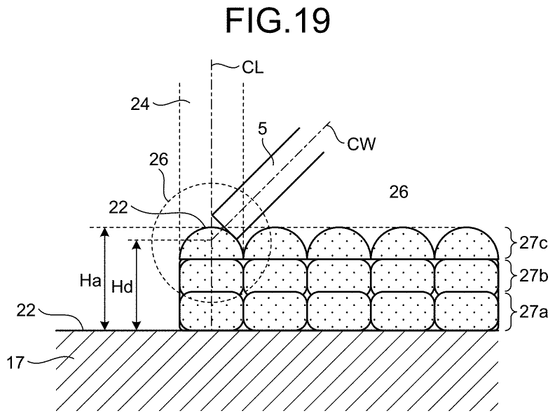

The additive working according to the second embodiment described above is effective in forming the second and subsequent dot bead layers when the additive manufacturing apparatus 100 forms the object 101. FIG. 19 is a schematic cross-sectional diagram in which the fourth dot bead layer is formed by the additive manufacturing apparatus 100 illustrated in FIG. 1. The following description refers to a case where the additive target surface 22 is the third dot bead layer 27c, as illustrated in FIG. 19. In FIG. 19, the wire 5 is discharged in a lower left direction from the right side in FIG. 19, that is, from the outer peripheral side of the laser beam 24. In the case of forming a deposit of layers of dot beads 32, it is likely that the already formed dot beads 32 reaches the height at which the end of the wire 5 is delivered. Then, the difference between the actual height Ha and the design height Hd becomes larger as the difference between the actual height and the design height of a single layer of dot beads 32 accumulates.

For example, the actual height Ha of the third dot bead layer 27c may be higher than the design height Hd of the third dot bead layer 27c expected. That is, it is likely that the already formed dot beads 32 reach the height at which the end of the wire 5 is delivered. The difference between the actual height Ha and the design height Hd becomes larger as the difference between the actual height and the design height of a single layer of dot beads 32 accumulates.

In this case, as illustrated in FIG. 19, the end of the wire 5 discharged from the wire nozzle 12 collides with the upper surface of the dot bead 32 at a position offset from the apex of the dot bead 32 in the process area 26 in a direction parallel to the additive target surface 22. Then, the central axis CW of the wire 5 whose end is in contact with the additive target surface 22, and the central axis CL of the laser beam 24 radiated onto the process area 26 do not intersect on the surface of the additive target surface 22, that is, on the surface of the dot bead 32 in the process area 26. That is, the accumulation of the difference between the actual height of the formed dot bead 32 and the design height of the dot bead 32 results in a situation where the end of the wire 5 fails to reach the central axis CL of the laser beam 24 radiated onto the process area 26.

In such a state, the dot bead 32 can be formed at a position offset from the central axis CL of the laser beam 24, or the dot bead 32 cannot be formed. Such a situation can occur in the second and subsequent layers of dot beads 32. The dot bead 32 newly formed in such a situation is located at a position offset from the circular area centered on the central axis CL of the laser beam 24, which is the expected formation position.

In the additive working according to the second embodiment, before the wire 5 is discharged, the wire nozzle 12 is placed at a height position where the end of the wire 5 is not in contact with the additive target surface 22 even after the wire 5 is discharged to a position where the wire 5 intersects the central axis CL of the laser beam 24. Then, the wire 5 is discharged toward the process area 26 to reach a position where the central axis CL of the laser beam 24 radiated onto the process area 26 and the end of the wire 5 intersect. Subsequently, the wire 5 is moved downward toward the additive target surface 22, whereby the end of the wire 5 is brought into contact with the additive target surface 22. As a result, in the second embodiment, it is possible to avoid the above-described situation where the end of the wire 5 fails to reach the central axis CL of the laser beam 24 radiated onto the process area 26, and to reliably form the dot bead 32 at the expected formation position of the dot bead 32.

Therefore, the additive working according to the second embodiment can achieve the effect of preventing a failure from occurring due to the accumulation of the difference between the actual height and the design height of the dot bead 32 in forming a plurality of dot bead layers.

### Third Embodiment

In the third embodiment, another mode of additive working by the additive manufacturing apparatus 100 illustrated in FIG. 1 will be described. The additive working according to the third embodiment differs from the additive working according to the first embodiment described above in the position of the end of the wire 5 discharged before the wire 5 is irradiated with the laser beam 24.

As described in the first embodiment, if the wire 5 is not brought into contact with the additive target surface 22 before the wire 5 is irradiated with the laser beam 24, a run-up phenomenon occurs immediately after the irradiation of the wire 5 with the laser beam 24 is started. As described above, the run-up phenomenon is a phenomenon where the lower portion of the molten wire 21 is attracted to the upper portion of the molten wire 21. The run-up phenomenon makes it likely that the molten wire 21 fails to be welded to the additive target surface 22.

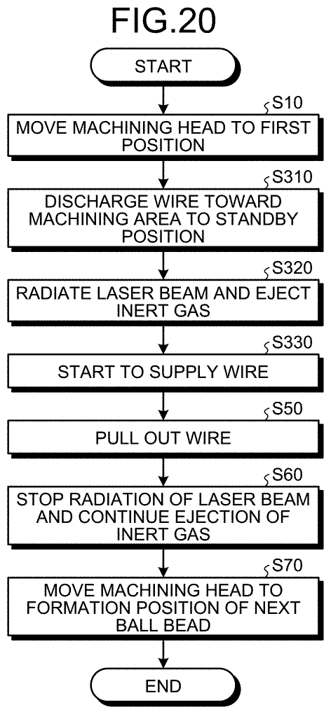

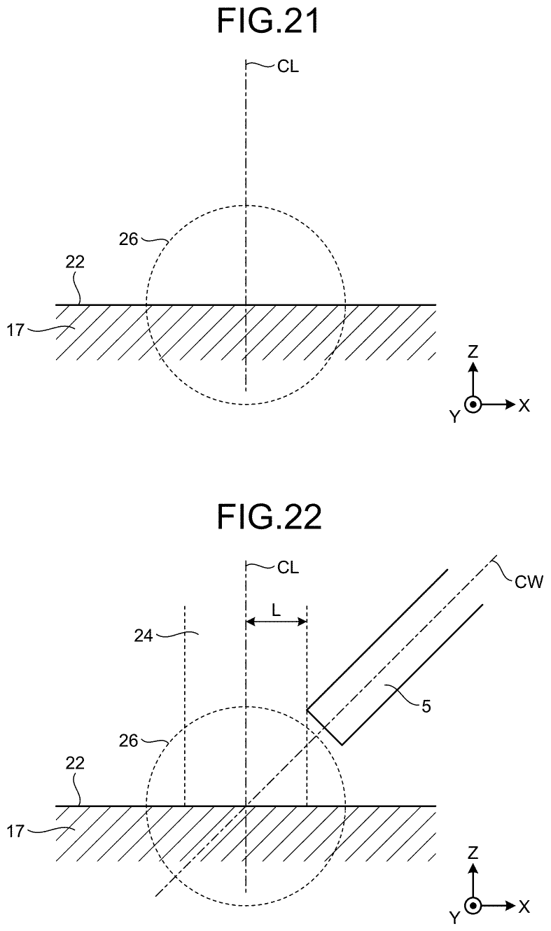

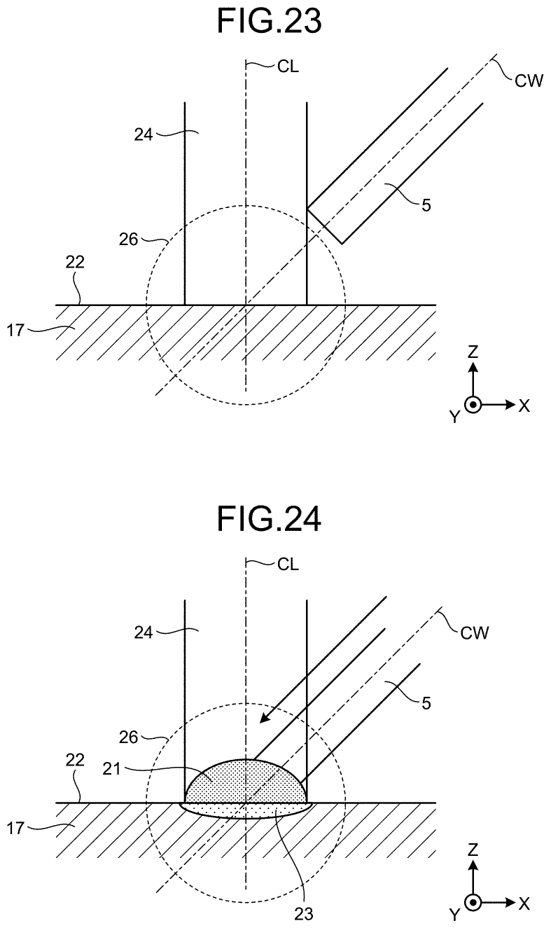

The third embodiment gives additive working for preventing a run-up phenomenon, using a method different from that of the first embodiment. Hereinafter, the operation of the additive manufacturing apparatus 100 according to the third embodiment will be described with reference to FIGS. 20 to 24. FIG. 20 is a flowchart for explaining the operation of the additive manufacturing apparatus 100 illustrated in FIG. 1 according to the third embodiment. FIG. 21 is a schematic cross-sectional diagram illustrating the position of the central axis CL of the laser beam 24, with the working head 10 of the additive manufacturing apparatus 100 illustrated in FIG. 1 moved to the first position. FIG. 22 is a schematic cross-sectional diagram in which the wire 5 is discharged to a standby position in the additive manufacturing apparatus 100 illustrated in FIG. 1. FIG. 23 is a schematic cross-sectional diagram in which the irradiation of the process area 26 with the laser beam 24 is started in the additive manufacturing apparatus 100 illustrated in FIG. 1. FIG. 24 is a schematic cross-sectional diagram in which the supply of the wire 5 to the process area 26 of the additive manufacturing apparatus 100 illustrated in FIG. 1 is started. FIGS. 21 to 24 illustrate the state of a peripheral region of the process area 26 on the additive target surface 22.

First, as illustrated in FIG. 21, step S10 described above is performed.

Next, in step S310, the wire nozzle 12 discharges the wire 5 toward the process area 26 as illustrated in FIG. 22. Here, the wire 5 is discharged to a position where the distance L between the central axis CL of the laser beam 24 radiated onto the process area 26 and the end of the wire 5 is in the range of 0.5 to 2.3 times the radius of the laser beam 24, which is a dimension of about the beam radius ω defined by the beam radius defined by a second moment width called D4σ, in the in-plane direction of the additive target surface 22. The beam radius defined by a second moment width called D4σ is twice the standard deviation σ of the beam intensity distribution. The position where the distance L is in the range of 0.5 to 2.3 times the radius of the laser beam 24 is a standby position where energy exceeding the melting point of the wire 5 is not supplied to the wire 5 when the wire 5 is supplied into the laser beam 24 from the outer peripheral side of the laser beam 24 toward the central axis CL of the laser beam 24. That is, unlike in the case of the first embodiment, the end of the wire 5 is not brought into contact with the additive target surface 22 before the process area 26 on the additive target surface 22 is irradiated with the laser beam 24.

Next, in step S320, the laser beam 24 is radiated toward the process area 26 as illustrated in FIG. 23. In conjunction with the radiation of the laser beam 24, the ejection of the inert gas 25 from the gas nozzle 13 to the process area 26 is started.

Next, in step S330, the supply of the wire 5 to the process area 26 is started as illustrated in FIG. 24. That is, the wire nozzle 12 discharges the wire 5 further toward the additive target surface 22. As a result, the wire 5 is delivered into the laser beam 24, and the wire 5 is melted. Then, the molten wire 21 is welded to the additive target surface 22, and the dot bead 32, which is the deposit 18, is formed in the process area 26 of the additive target surface 22.

After that, steps S50 to S70 described above are performed in the same manner as in the first embodiment as illustrated in FIGS. 9 to 11.

In the process of forming the second dot bead layer, the additive target surface 22 is the upper surface of the already formed layer of dot beads 32.

Note that the control method according to the second embodiment described above may be applied to the additive working according to the third embodiment.

As described above, in the additive working according to the third embodiment, before the process area 26 on the additive target surface 22 is irradiated with the laser beam 24, the wire 5 is discharged to a position where the distance L between the central axis CL of the laser beam 24 radiated onto the process area 26 and the end of the wire 5 is in the range of 0.5 to 2.3 times the radius of the laser beam 24, which is a dimension of about the beam radius co defined by the beam radius defined by a second moment width called D4σ. Then, the laser beam 24 is radiated toward the process area 26, with the end of the wire 5 placed at a position in the range of 0.5 to 2.3 times the laser beam 24. After that, the wire 5 is supplied into the laser beam 24.

In the case of the additive working according to the third embodiment described above, it is possible to prevent the wire 5 from being heated by the laser beam 24 above the melting point before the supply of the wire 5 is started, and to prevent a run-up phenomenon in the molten wire 21. Then, before the wire 5 is supplied into the laser beam 24 and is melted, the temperature of the additive target surface 22 defining a surface of the base material 17 rises, and the additive target surface 22 melts into the molten pool 23. After that, the wire 5 is supplied into the laser beam 24, and the wire 5 in the laser beam 24 is melted.

Because the molten wire 21 is attracted to the higher temperature side, the molten wire 21 is attracted not to the unmelted portion of the wire 5 close to the wire nozzle 12 but to the molten pool 23 having its temperature rising. As a result, in the additive working according to the third embodiment, a run-up phenomenon in the molten wire 21 does not occur, the molten wire 21 is easily welded to the additive target surface 22, and the wire 5 can be reliably welded to the additive target surface 22.

As described above, in the event of a run-up phenomenon where the lower portion of the molten wire 21 is attracted to the upper portion of the molten wire 21 and a run-up phenomenon where the molten wire 21 is attracted to the unmelted portion of the wire 5 close to the wire nozzle 12, it is necessary to set a relatively long supply time of the wire 5 so as to secure the time for reliably pressing the molten wire 21 against the additive target surface 22 such that the molten wire 21 is welded to the additive target surface 22.

In contrast, in the additive working according to the third embodiment, because the wire 5 can be supplied into the laser beam 24 in a condition where the above-mentioned run-up phenomenon does not occur, it is not necessary to set a relatively long supply time of the wire 5, and the supply time of the wire 5 can be shortened. Because the supply time of the wire 5 is shortened, a smaller dot bead 32 can be produced with a shorter melting time of the wire 5 and a smaller amount of the molten wire 21 than in the cases of the first and second embodiments.

Therefore, the additive working according to the third embodiment prevents the wire 5 from being heated by the laser beam 24 above the melting point before the supply of the wire 5 is started, and forms the molten pool 23 before the supply of the wire 5 is started, whereby a run-up phenomenon in the molten wire 21 is prevented. As a result, the time for pressing the molten wire 21 against the additive target surface 22 at the time of the start of the melting of the wire 5 can be shortened, and the supply time of the wire 5 can be shortened. Consequently, the amount of the wire 5 supplied in forming the dot bead 32 is reduced, so that a small dot bead 32 can be produced, and the formation accuracy of the object 101 can be improved.

If a relatively long supply time of the wire 5 is set because of the above described run-up phenomenon, such a supply time of the wire 5 is only about 0.2 seconds longer than that based on the assumption that a run-up phenomenon does not occur. This means that the amount of the molten wire 21 supplied in forming the dot bead 32 does not increase significantly, and it is still possible to obtain the object 101 with high accuracy from the viewpoint of formation accuracy. The additive working according to the third embodiment can manufacture the object 101 with higher formation accuracy.

The range of the above-described distance L between the central axis CL of the laser beam 24 radiated onto the process area 26 and the end of the wire 5 will be described. The range of the distance L is determined on the basis of the following conditions.

First, preconditions are set as follows.

The dot bead 32 is created with the radiation time of the laser beam set to 24 to 0.3 seconds or less.

Before the wire 5 reaches the additive target surface 22, the additive target surface 22 is melted to form the molten pool 23.

The time required to form the molten pool 23 larger than 1.2 mm that is the wire diameter (mm) of the wire 5 is about 0.1 sec, where the material of the wire 5 is SUS304, the wire diameter (mm) of the wire 5 is 1.2 mm, the output (W) of the laser beam 24 is 800 W, and the beam diameter C (mm) of the laser beam 24 is 2.0 mm.

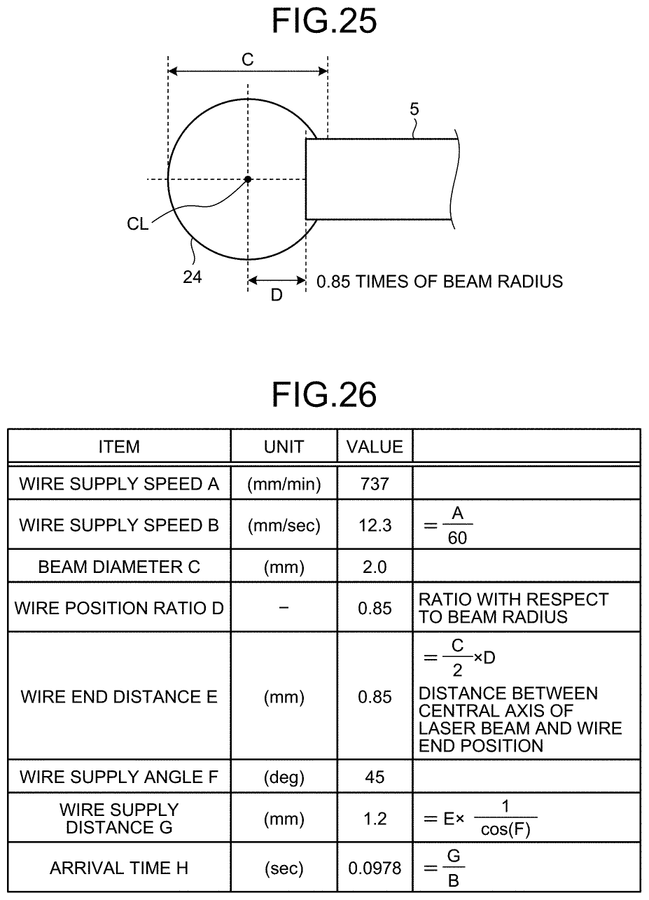

Next, a method of calculating the end position of the wire 5 will be described with reference to FIGS. 25 and 26. FIG. 25 is a schematic diagram for explaining the method of calculating the end position of the wire 5 according to the third embodiment of the present invention. FIG. 26 is a list of conditions for explaining the method of calculating the end position of the wire 5 according to the third embodiment of the present invention.

Under the above preconditions, let the wire supply angle F of the wire 5 be 45 degrees, the wire supply speed A (mm/min) of the wire 5 be 737 mm/min, and the wire supply speed B (mm/sec) of the wire 5 be 737 mm/60 min=12.3 mm/sec.

Then, let the wire position ratio D be 0.85, which is the ratio of the distance from the central axis CL of the laser beam 24 to the end of the wire 5 relative to the beam radius, as viewed in the radiation direction of the laser beam 24. Therefore, the wire end distance E, which is the distance from the central axis CL of the laser beam 24 to the end of the wire 5, is 0.85 times the beam radius of the laser beam 24. That is, the wire end is located a distance of 0.85 mm (2.0 mm/2×0.85=0.85 mm) from the central axis CL of the laser beam 24, as viewed in the radiation direction of the laser beam 24. Thus, the end position of the wire 5 is 0.85 mm short of the central axis CL of the laser beam 24 in the beam radius direction.

The wire supply angle F, which is the supply angle of the wire 5, is the angle defined by the direction of the central axis CL of the laser beam 24 and the direction of the central axis CW of the wire 5 discharged from the wire nozzle 12, as viewed in the radiation direction of the laser beam 24. The position located short of the central axis CL of the laser beam 24 is denied as a position on a side of of the wire nozzle 12 relative to the laser beam 24, as viewed in the direction perpendicular to the radiation direction of the laser beam 24. In this case, the wire supply distance G for the wire 5 supplied from the end position of the wire 5 to the central axis CL of the laser beam 24 is E×1/cos (F)=1.2 mm. The arrival time H required for the end of the wire 5 to reach the central axis CL of the laser beam 24 from the wire end position is 0.1 sec.

In the case of creating the dot bead 32 with the radiation time of the laser beam 24 set to 0.3 sec or less, with 0.1 sec of the feeding time of the wire 5 taken into consideration, the end of the wire 5 can be positioned up to a distance away from the position that provides the wire position ratio D of 0.85, such that it takes 0.2 sec for the end of the wire 5 to reach the position that provides the wire position ratio D of 0.85. Calculated under the above conditions, the position of the end of the wire 5 is short of the central axis CL of the laser beam 24 by a distance of 1.7 times the beam radius. Therefore, under the above conditions, the position of the end of the wire 5 is in the range where the distance L is 0.85 to 1.7 times the beam radius.

The distance L changes as the wire supply angle changes. Assuming that the wire supply angle is in the range of 20 to 70 degrees, the position of the end of the wire 5 is in the range where the distance L is 0.5 to 2.3 times the beam radius.

In the above-described case, the laser beam 24 and the central axis CW of the wire 5 are non-coaxial. However, the above-mentioned effect can also be obtained when the laser beam 24 and the central axis CW of the wire 5 are coaxial. In the case where the laser beam 24 and the central axis CW of the wire 5 are coaxial, the wire 5 is supplied to a standby position where the distance between the additive target surface 22 and the end of the wire 5 is in the range of 0.5 to 2.3 times the radius of the laser beam 24, after which the process area 26 is irradiated with the laser beam 24 and the wire 5 is further supplied to the process area 26. As a result, the above-mentioned effect can also be obtained when the laser beam 24 and the central axis CW of the wire 5 are coaxial. In the case where the laser beam 24 and the central axis CW of the wire 5 are coaxial, it is preferable to supply the wire 5 to a standby position where the distance between the additive target surface 22 and the end of the wire 5 is in the range of 0.6 to 1.2 times the radius of the laser beam 24, and subsequently irradiate the process area 26 with the laser beam 24, and further supply the wire 5 to the process area 26.

The additive working according to the third embodiment involves neither the operation for bringing the molten wire 21 into contact with the additive target surface 22 nor the operation for pressing the molten wire 21 against the additive target surface 22. As described above, the difference between the actual height of the dot bead 32 and the design height of the dot bead 32 can accumulate as a plurality of dot bead layers are formed. As a result, a situation where the already formed dot beads 32 reach the height at which the end of the wire 5 is delivered may occur.

In order to reliably form the dot bead 32 in such a situation, it is preferable to strictly control the end position of the wire 5 and the interval in the height direction between the wire 5 and the additive target surface 22. The height direction is the Z-axis direction.

By strictly controlling the interval in the height direction between the wire 5 and the additive target surface 22, it is possible to avoid a situation where the end of the wire 5 fails to reach the position of the central axis CL of the laser beam 24 on the upper surface of the dot bead 32 as the additive target surface 22. As a result, it is possible to prevent the new dot bead 32 from being formed at a position offset from the position of the central axis CL of the laser beam 24, or to prevent a failure to create the dot bead 32.

For example, in a case where the additive target surface 22 is the second or higher-order dot bead layer, the control device 1 detects the height of the additive target surface 22 and the height of the end position of the wire 5 by using a sensor or an image processing technique between steps S310 and S330. Then, the control device 1 determines, on the basis of the detection result, whether the end of the wire 5 can reach the position of the central axis CL of the laser beam 24 on the upper surface of the dot bead 32 as the additive target surface 22 when the wire 5 is supplied toward the additive target surface 22 in step S330.

In response to determining that the end of the wire 5 fails to reach the position of the central axis CL of the laser beam 24 on the upper surface of the dot bead 32 as the additive target surface 22, the control device 1 performs control for executing step S330 after the height position of the working head 10 is raised. That is, the control device 1 performs control for executing step S330 after moving the wire 5 placed at a standby position in step S310, upward to such a height position that the end of the wire 5 can reach the position of the central axis CL of the laser beam 24 on the upper surface of the dot bead 32 as the additive target surface 22 when the wire 5 is supplied toward the additive target surface 22 in step S330. This enables the end of the wire 5 to always reach the position of the central axis CL of the laser beam 24 on the upper surface of the dot bead 32 as the additive target surface 22, so that the shape accuracy of the object 101 can be improved.

To control the height of the wire 5 on the basis of the end position of the wire 5 and the interval in the height direction between the wire 5 and the additive target surface 22 is also effective in the additive working according to the first embodiment described above.

As described above, the additive working according to the third embodiment can achieve the effect that a run-up phenomenon in the molten wire 21 does not occur, the molten wire 21 is easily welded to the additive target surface 22, and the wire 5 can be reliably welded to the additive target surface 22.

### Fourth Embodiment

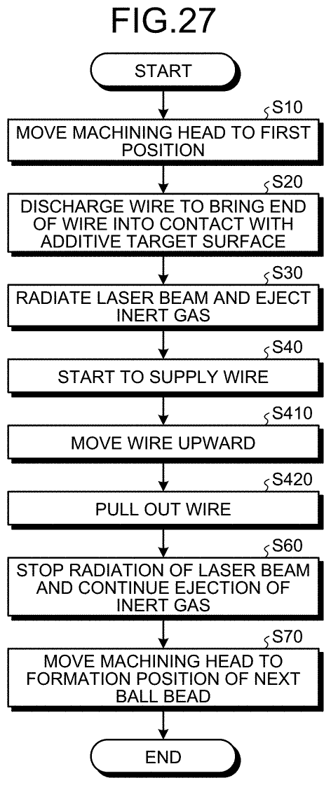

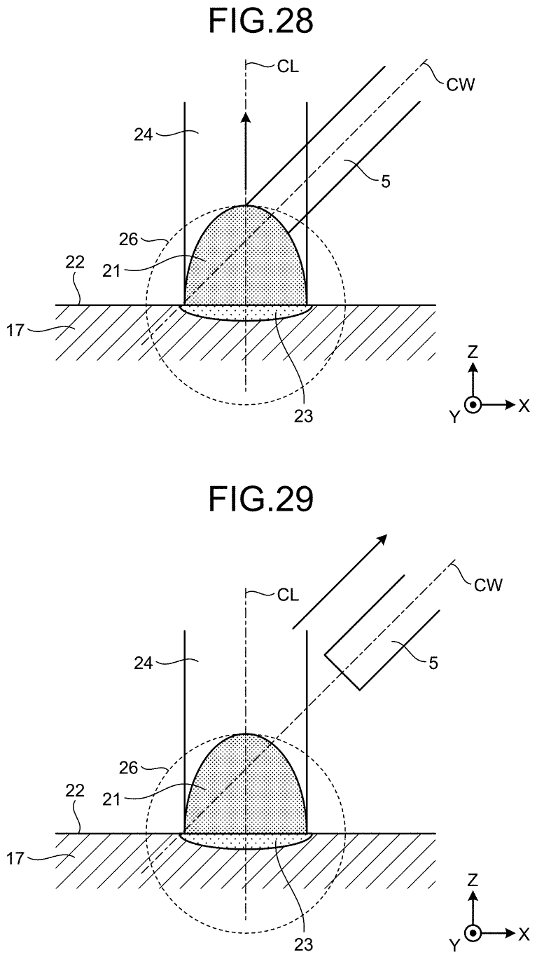

In the fourth embodiment, another mode of additive working by the additive manufacturing apparatus 100 illustrated in FIG. 1 will be described. The additive working according to the fourth embodiment differs from the additive working according to the first embodiment described above in the method of pulling out the wire 5 from the process area 26. Hereinafter, the operation of the additive manufacturing apparatus 100 according to the third embodiment will be described with reference to FIGS. 27 to 29. FIG. 27 is a flowchart for explaining the operation of the additive manufacturing apparatus 100 illustrated in FIG. 1 according to the fourth embodiment. FIG. 28 is a schematic cross-sectional diagram in which the wire 5 of the additive manufacturing apparatus 100 illustrated in FIG. 1 moves upward. FIG. 29 is a schematic cross-sectional diagram in which the wire 5 is pulled out from the process area 26 of the additive manufacturing apparatus 100 illustrated in FIG. 1.

First, as illustrated in FIGS. 5 to 8, steps S10 to S40 described above are performed in the same manner as in the first embodiment.

Next, the wire 5 is pulled out from the process area 26 in two stages. First, in step S410, the first stage is performed. In the first stage, as illustrated in FIG. 28, the working head 10 moves in the Z-axis direction by a predetermined distance, thereby moving the wire nozzle 12 upward. As a result, the wire 5 supplied to the process area 26 moves upward, and the position where the molten wire 21 is generated moves upward. At this time, the wire 5 is moved upward to such an extent that the wire 5 does not become separate from the molten wire 21. The supply of the wire 5 is continued while the wire 5 is moved upward. The predetermined distance is, for example, 3 mm or less.

Next, in step S420, the second stage is performed. In the second stage, the wire 5 is pulled out from the process area 26 as illustrated in FIG. 29.

After that, steps S60 and S70 described above are performed in the same manner as in the first embodiment as illustrated in FIGS. 10 and 11.

Note that the control method according to the second embodiment or the control method according to the third embodiment described above may be applied to the additive working according to the fourth embodiment.

As described above, in the additive working according to the fourth embodiment, the wire 5 is moved upward to such an extent that the wire 5 does not come out from the mass of the molten wire 21 welded to the additive target surface 22, and then the wire 5 is pulled out in the direction opposite to the direction of supply of the wire 5. These two stages to pull the wire 5 out from the molten wire 21 welded to the additive target surface 22 makes it possible to move upward the supply position of the molten wire 21 that is newly supplied to the mass of the molten wire 21 welded to the additive target surface 22, thereby increasing the height of the dot bead 32. Increasing the height of the dot bead 32 makes it possible to form the dot bead 32 having a small diameter even when the wire 5 is supplied for a long time. As a result, the object 101 having a narrow width can be formed.

The wire 5 does not melt immediately after entering the laser beam 24. Rather, as the wire 5 approaches the central axis CL of the laser beam 24, the temperature of the wire 5 reaches the melting point and then the wire 5 melts. Therefore, in a case where the supply time of the wire 5 is set to a relatively long time of, for example, one second or more in order to form the dot bead 32 having a large diameter, a long portion of the wire 5 is left unmelted in the mass of the molten wire 21 welded to the additive target surface 22. When The long the unmelted portion of the wire 5 in the mass of the molten wire 21 is long, the surface portion of the mass of the molten wire 21 is pulled by the unmelted portion of the wire 5 when the wire 5 is pulled out from the mass of the molten wire 21. As a result, the shape of the dot bead 32 may be distorted.

In contrast, the above-described operation of pulling out the wire 5 through the two stages causes the unmelted end portion of the wire 5 to move upward in the mass of the molten wire 21, so that the length of the unmelted portion of the wire 5 that is pulled out from the mass of the molten wire 21 can be shortened, and the dot bead 32 can be prevented from being distorted in shape. As a result, the repeatability of the shape of the dot bead 32 is improved, and the shape accuracy of the object 101 can be improved.

### Fifth Embodiment

In the additive manufacturing apparatus 100, the wire 5 is supplied in non-coaxial relation with the central axis CL of the laser beam 24. In a case where the moving direction of the working head 10 and the supply direction of the wire 5 are set with the wire 5 positioned in such a manner as to ride over the dot bead 32 previously formed on the additive target surface 22, the end of the wire 5 may collide with the dot bead 32 when the working head 10 moves, depending on the height of the dot bead 32 and the height of the end of the wire 5. A collision between the end of the wire 5 and the dot bead 32 causes the wire 5 to bend and form an unexpected gap between the end of the wire 5 and the additive target surface 22. As a result, working failure, which fails to perform the welding of the wire 5 as planned, may occur.

The control device 1 can prevent that working failure because, when the working head 10 moves, the control device 1 controls the moving direction of the working head 10 and the supply direction of the wire 5 such that the working head 10 moves and the wire 5 is supplied in such directions as not to allow the wire 5 to be supplied riding over the dot bead 32 already formed on the additive target surface 22. Such directions as not allow the wire 5 to be supplied riding over the dot bead 32 already formed on the additive target surface 22 are a direction that does not allow the wire 5 supplied to the process area 26 to overlap the dot bead 32 already formed on the additive target surface 22, in a plane of the additive target surface 22. That is, it is possible to prevent the above-described working failure by controlling the moving direction of the wire nozzle 12 and the supply direction of the wire 5 such that the wire nozzle 12 moves and the wire 5 is supplied in such directions as not to allow the wire 5 supplied to the process area 26 to overlap the dot bead 32 already formed on the additive target surface 22, in a plane of the additive target surface 22.

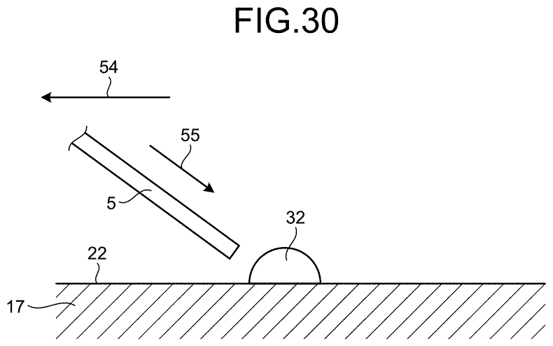

FIG. 30 is a diagram illustrating an example of the relationship between the moving direction 54 of the working head 10 and the supply direction 55 of the wire 5 according to the fifth embodiment of the present invention. For example, it is possible to prevent the above-described working failure by setting the moving direction 54 of the working head 10 and the supply direction 55 of the wire 5 such that the directions 54, 55 have their components opposite to each other in the in-plane direction of the additive target surface 22, as illustrated in FIG. 30.

In a case where the workpiece is rotated using the rotation mechanism 16 to move the position of the process area 26 without moving the working head 10, it is possible to prevent the above-described working failure by controlling the rotation direction of the workpiece and the supply direction of the wire 5 such that the workpiece is rotated and the wire 5 is supplied in such directions as not to allow the wire 5 supplied to the process area 26 to overlap the dot bead 32 already formed on the additive target surface 22, in a plane of the additive target surface 22. Note that the above-mentioned control can be applied where the rotation mechanism 16 is used to rotate the workpiece on the second axis to thereby perform circular additive working in a plane of the additive target surface 22. The above-mentioned control can also be applied where the working head 10 is moved to allow the material supply unit and the irradiation unit to move in a circle in the in-plane direction of the additive target surface 22 to thereby perform circular additive working in the in-plane direction of the additive target surface 22.

### Sixth Embodiment

In the sixth embodiment, another mode of additive working by the additive manufacturing apparatus 100 illustrated in FIG. 1 will be described. The additive working according to the sixth embodiment differs from the additive working according to any of the above-described embodiments in that the supply operation of the wire 5 is started before the wire 5 is irradiated with the laser beam 24.

The supply operation of the wire 5 is started before the wire 5 is irradiated with the laser beam 24. Namely, the supply operation of the wire 5 has already been started by the time the radiation of the laser beam 24 is started. Therefore, the molten wire 21 is smoothly welded to the additive target surface 22. As a result, the molten wire 21 is stably welded to the additive target surface 22, thereby preventing the molten wire 21 from failing to be welded to the additive target surface 22.

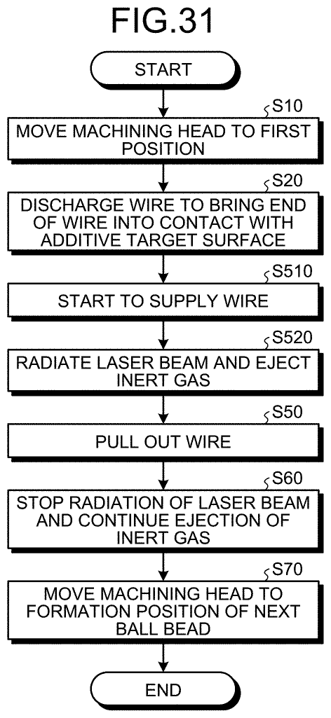

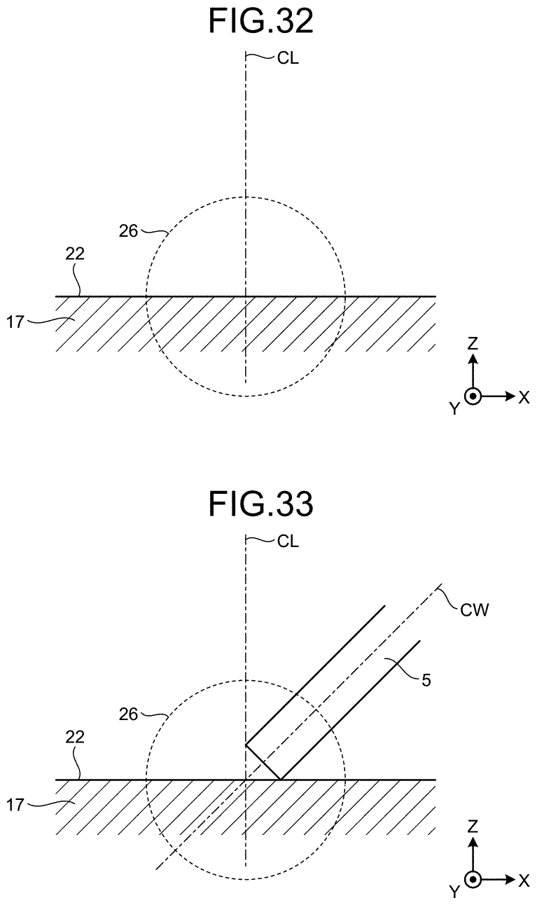

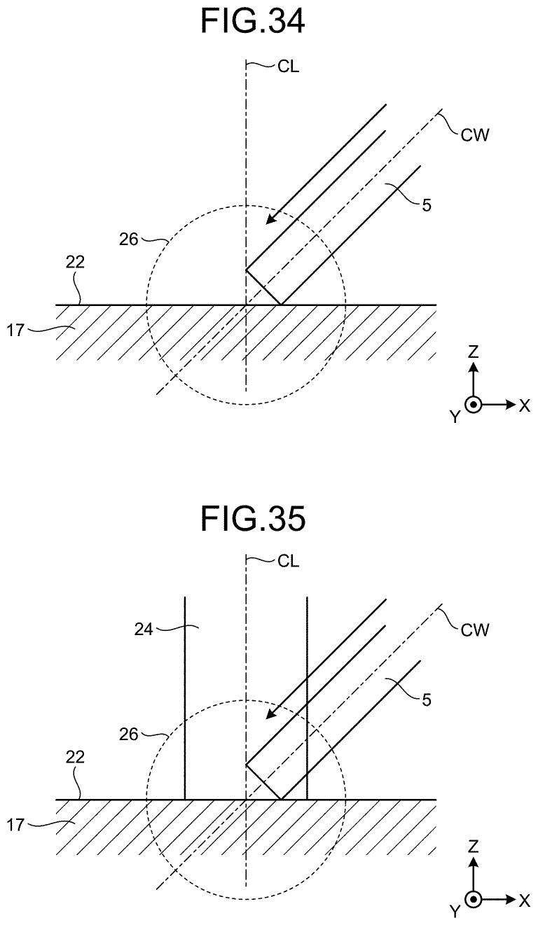

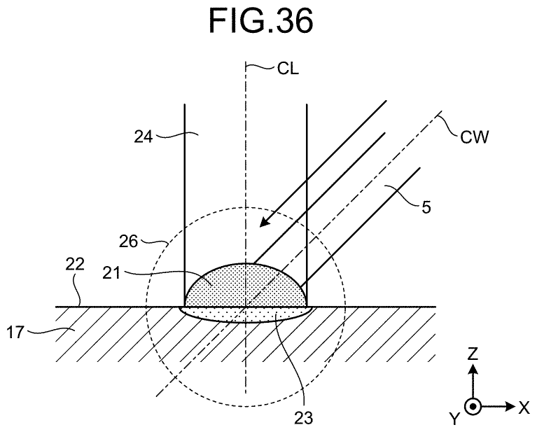

Hereinafter, additive working by the additive manufacturing apparatus 100 according to the sixth embodiment will be described with reference to FIGS. 31 to 36. FIG. 31 is a flowchart for explaining the operation of the additive manufacturing apparatus 100 illustrated in FIG. 1 according to the sixth embodiment. FIG. 32 is a schematic cross-sectional diagram illustrating the position of the central axis CL of the laser beam 24, with the working head 10 of the additive manufacturing apparatus 100 illustrated in FIG. 1 moved to the first position. FIG. 33 is a schematic cross-sectional diagram in which the end of the wire 5 discharged to the process area 26 is in contact with the additive target surface 22 in the additive manufacturing apparatus 100 illustrated in FIG. 1. FIG. 34 is a schematic cross-sectional diagram in which the supply of the wire 5 to the process area 26 of the additive manufacturing apparatus 100 illustrated in FIG. 1 is started. FIG. 35 is a schematic cross-sectional diagram in which the irradiation of the process area 26 with the laser beam 24 is started in the additive manufacturing apparatus 100 illustrated in FIG. 1. FIG. 36 is a schematic cross-sectional diagram in which the molten wire 21 is welded to the additive target surface 22 in the additive manufacturing apparatus 100 illustrated in FIG. 1. FIGS. 32 to 36 illustrate the state of a peripheral region of the process area 26 on the additive target surface 22.

First, as illustrated in FIG. 32, step S10 described above is performed.

Next, as illustrated in FIG. 33, step S20 described above is performed. That is, as illustrated in FIG. 33, the wire nozzle 12 discharges the wire 5 obliquely from above the process area 26 toward the process area 26 on the additive target surface 22, and brings the end of the wire 5 into contact with the additive target surface 22. That is, the end of the wire 5 is brought into contact with the additive target surface 22 before the process area 26 on the additive target surface 22 is irradiated with the laser beam 24.

At this time, it is preferable that the central axis CW of the wire 5 discharged from the wire nozzle 12 and brought into contact with the additive target surface 22 and the central axis CL of the laser beam 24 radiated onto the process area 26 intersect at the surface of the additive target surface 22. Alternatively, it is preferable that the central axis CW of the wire 5 intersect the surface of the additive target surface 22 within the beam radius of the laser beam 24 between the wire nozzle 12 and the central axis CL of the laser beam 24 radiated onto the process area 26. As a result, the dot bead 32 can be formed on the additive target surface 22 such that the formed dot bead has its center located on the intersection of the central axis CW of the wire 5 and the central axis CL of the laser beam 24 radiated onto the process area 26.

Next, in step S510, the wire nozzle 12 starts to supply the wire 5 to the process area 26 as illustrated in FIG. 34. That is, the wire nozzle 12 discharges the wire 5 further toward the additive target surface 22. After that, the supply of the wire 5 to the process area 26 is continued for a predetermined supply time.

Next, in step S520, as illustrated in FIG. 35, the laser beam 24 is radiated toward the process area 26 on the additive target surface 22, such that the wire 5 placed in the process area 26 on the additive target surface 22 is irradiated with the laser beam. In conjunction with the radiation of the laser beam 24, the ejection of the inert gas 25 from the gas nozzle 13 to the process area 26 is started. As a result, the wire 5 placed in advance in the process area 26 and the metallic wire supplied to the process area 26 after the start of the radiation of the laser beam 24 are melted to form the molten wire 21, which is then welded to the additive target surface 22 as illustrated in FIG. 36. Consequently, the dot bead 32, which is the deposit 18, is formed in the process area 26 of the additive target surface 22.

In this case, it is preferable that the inert gas 25 be ejected from the gas nozzle 13 for a predetermined fixed time before the additive target surface 22 is irradiated with the laser beam 24. This enables the active gas such as oxygen remaining in the gas nozzle 13 to be removed from the gas nozzle 13.

After that, steps S50 to S70 described above are performed in the same manner as in the first embodiment as illustrated in FIGS. 9 to 11.

Note that the control method in steps S110 to S130 according to the second embodiment described above may be applied to the above-mentioned additive working.

As described above, the supply operation of the wire 5 is started before the wire 5 is irradiated with the laser beam 24. Namely, the supply operation of the wire 5 has already been started by the time the radiation of the laser beam 24 is started. Therefore, the molten wire 21 is smoothly welded to the additive target surface 22.

As described above, the end of the wire 5 is brought into contact with the additive target surface 22 before the process area 26 on the additive target surface 22 is irradiated with the laser beam 24. Namely, the wire 5 is irradiated with the laser beam 24 after the supply operation of the wire 5 is started. Therefore, the laser radiation time for forming the desired dot bead 32 can be shortened to the minimum limit of the laser radiation time required for forming the dot bead 32. As a result, the reduced-size dot bead 32 can be formed, and the dot bead 32 having a small diameter can be formed, so that the shape accuracy of the object 101 can be improved.

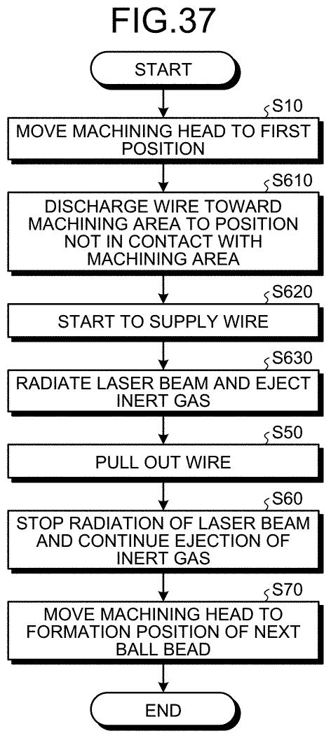

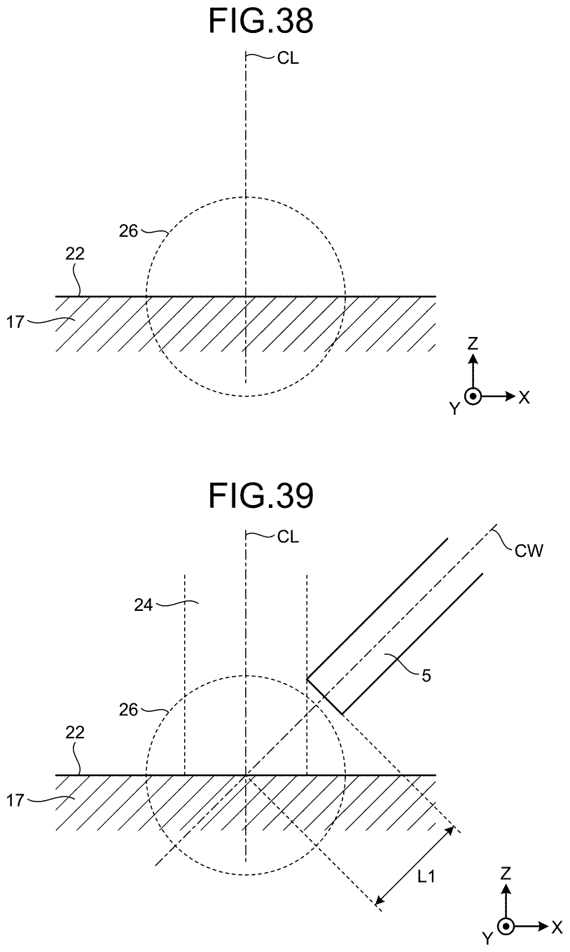

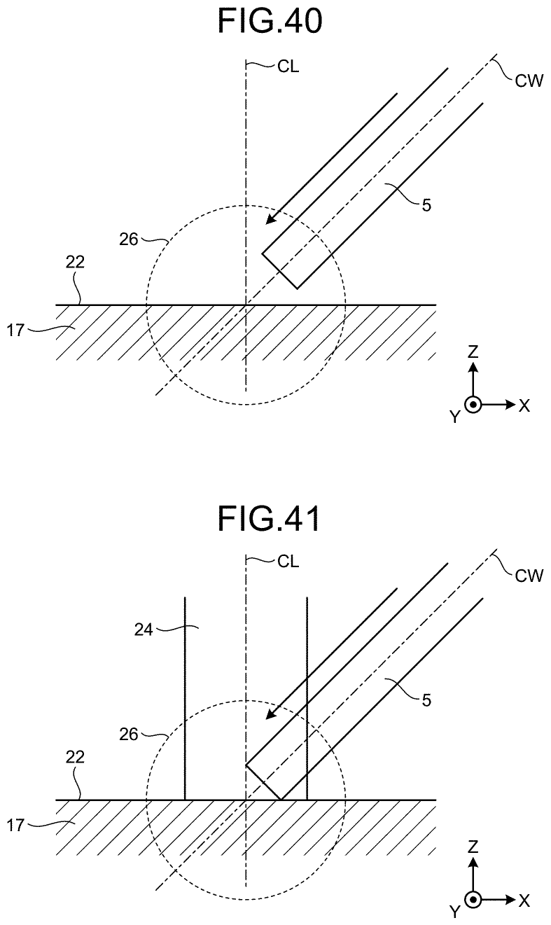

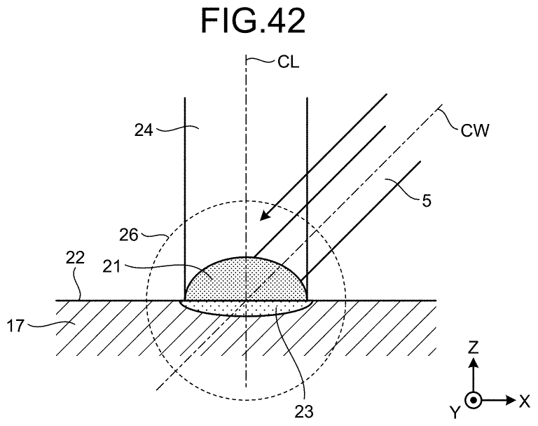

Next, another example of additive working by the additive manufacturing apparatus 100 according to the sixth embodiment will be described with reference to FIGS. 37 to 42. FIG. 37 is a flowchart for explaining another example of the operation of the additive manufacturing apparatus 100 illustrated in FIG. 1 according to the sixth embodiment. FIG. 38 is a schematic cross-sectional diagram illustrating the position of the central axis CL of the laser beam 24, with the working head 10 of the additive manufacturing apparatus 100 illustrated in FIG. 1 moved to the first position. FIG. 39 is a schematic cross-sectional diagram in which the wire 5 is discharged to a position where the end of the wire 5 is not in contact with the additive target surface 22 in the additive manufacturing apparatus 100 illustrated in FIG. 1. FIG. 40 is a schematic cross-sectional diagram in which the supply of the wire 5 to the process area 26 of the additive manufacturing apparatus 100 illustrated in FIG. 1 is started. FIG. 41 is a schematic cross-sectional diagram in which the irradiation of the process area 26 with the laser beam 24 is started in the additive manufacturing apparatus 100 illustrated in FIG. 1. FIG. 42 is a schematic cross-sectional diagram in which the molten wire 21 is welded to the additive target surface 22 in the additive manufacturing apparatus 100 illustrated in FIG. 1. FIGS. 38 to 42 illustrate the state of a peripheral region of the process area 26 on the additive target surface 22.

First, as illustrated in FIG. 38, step S10 described above is performed.

Next, in step S610, the wire nozzle 12 discharges the wire 5 toward the process area 26 as illustrated in FIG. 39. Here, the wire 5 is discharged to a position where the end of the wire 5 is not in contact with the process area 26, that is, to a position where the end of the wire 5 is not in contact with the additive target surface 22. For example, the wire 5 is discharged to a position located the radius of the laser beam 24 radiated onto the process area 26, away from the central axis CL of the laser beam 24 radiated onto the process area 26 toward the wire nozzle 12. That is, the wire 5 is discharged to a position on the outer circumference of the laser beam 24 on a side of the wire nozzle 12.

Note that before the supply of the wire 5 is started, the end of the wire 5 may be discharged to a position where the end of the wire 5 is not in contact with the additive target surface 22, the position being located outside the radius of the laser beam 24 radiated onto the process area 26 and on a wire-nozzle-side of the central axis CL of the laser beam 24 radiated onto the process area 26. Alternatively, before the supply of the wire 5 is started, the end of the wire 5 may be discharged to a position where the end of the wire 5 is within the radius of the laser beam 24 radiated onto the process area 26, but is not in contact with the additive target surface 22, the position being located on the wire-nozzle-side of the central axis CL of the laser beam 24 radiated onto the process area 26.

At this time, it is preferable that the central axis CW of the wire 5 discharged from the wire nozzle 12 and not in contact with the additive target surface 22 and the central axis CL of the laser beam 24 radiated onto the process area 26 intersect at the surface of the additive target surface 22. Alternatively, the central axis CW of the wire 5 intersect the surface of the additive target surface 22 within the beam radius of the laser beam 24 between the wire nozzle 12 and the central axis CL of the laser beam 24 radiated onto the process area 26. As a result, the dot bead 32 can be formed on the additive target surface 22 such that the formed dot bead has its center located on the intersection of the central axis CW of the wire 5 and the central axis CL of the laser beam 24 radiated onto the process area 26.

In order to improve the shape accuracy of the dot bead 32, it is preferable that the distance L1 between the wire 5 and the process area 26 be equal to or larger than a distance by which the wire 5 is supplied during the time in which the supply speed of the wire 5 reaches a prescribed value after the supply of the wire 5 is started, as described below. The inventors have found through experiments that it takes about 0.2 to 0.5 seconds for the supply speed of the wire 5 to reach the prescribed value. Therefore, for example, in a case where the prescribed value of the supply speed of the wire 5 is 737 mm/min, it is preferable that the wire 5 be placed away from the process area 26 by the distance L1 in the range of 16 to 40 μm or longer than 40 μm.

Therefore, as will be described later, it is preferable that the wire 5 be placed a distance away, which distance requires 0.2 seconds or more to be taken from the start of the supply of the wire 5 to the arrival of the wire 5 at the process area 26. The wire 5 is placed a distance away, which distance requires 0.2 seconds or more to be taken from the start of the supply of the wire 5 to the arrival of the wire 5 at the process area 26. The supply operation of the wire 5 is started before the wire 5 is irradiated with the laser beam 24. As a result, it is possible to ensure that the supply speed of the wire 5 reaches the prescribed value by the time the irradiation of the wire 5 with the laser beam 24 is started.

Next, in step S620, the wire nozzle 12 starts to supply the wire 5 to the process area 26 as illustrated in FIG. 40. That is, the wire nozzle 12 discharges the wire 5 further toward the process area 26. After that, the supply of the wire 5 to the process area 26 is continued for a predetermined supply time.

Next, in step S630, as illustrated in FIG. 41, the laser beam 24 is radiated toward the process area 26 on the additive target surface 22, such that the wire 5 placed in the process area 26 on the additive target surface 22 is irradiated with the laser beam. In conjunction with the radiation of the laser beam 24, the ejection of the inert gas 25 from the gas nozzle 13 to the process area 26 is started. As a result, the wire 5 placed in advance in the process area 26 and the metallic wire supplied to the process area 26 after the start of the radiation of the laser beam 24 are melted to form the molten wire 21, which is then welded to the process area 26 as illustrated in FIG. 42. Consequently, the dot bead 32, which is the deposit 18, is formed in the process area 26 of the additive target surface 22.

In this case, it is preferable that the inert gas 25 be ejected from the gas nozzle 13 for a predetermined fixed time before the process area 26 is irradiated with the laser beam 24. This enables the active gas such as oxygen remaining in the gas nozzle 13 to be removed from the gas nozzle 13.

In order to improve the shape accuracy of the dot bead 32, it is preferable that the wire 5 be irradiated with the laser beam 24 at the same time as the wire 5 reaches the process area 26. However, as the creation of the object 101 progresses, the process area 26 may deviate from the expected height, in which case it can be difficult to always maintain the distance L1 at the set value.

To address that problem, the height of the process area 26 is measured before the dot bead 32 is formed, and the discharge position of the wire 5 in step S610 is controlled so that the distance L1 is adjusted to the set value. Alternatively, in step S610, the position of the end of the wire 5 is observed using a sensor or a measurement system 61 attached to the upper portion of the working head 10, and the discharge position of the end of the wire 5 is controlled so that the distance L1 is adjusted to the set value.

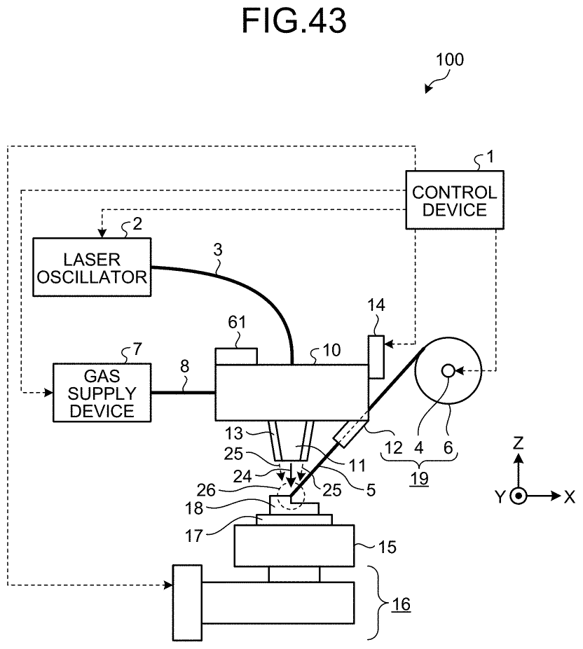

FIG. 43 is a diagram in which the measurement system 61 is provided in the additive manufacturing apparatus 100 illustrated in FIG. 1. An imaging device such as a camera and an image processing device can be used for the measurement system 61. As a result, the distance L1 can be maintained at the set value, and the wire 5 can be irradiated with the laser beam 24 at the same time as the wire 5 reaches the process area 26, so that the shape accuracy of the dot bead 32 can be improved.

In the case where the position of the wire 5 is observed with a camera attached to the upper portion of the working head 10, the moment at which the wire 5 reaches the process area 26 is identified from an image captured by the camera, thereby making it possible to irradiate the wire 5 with the laser beam 24 at the same time as the wire 5 reaches the process area 26. That is, that is, on the basis of the observation result of the position of the end of the wire 5 in the measurement system 61, the control device 1 controls the timing at which to irradiate the process area 26 with the laser beam 24.

After that, steps S50 to S70 described above are performed in the same manner as in the first embodiment as illustrated in FIGS. 9 to 11.

Note that the control method in steps S110 to S130 according to the second embodiment described above may be applied to the above-mentioned additive working.

In another example of additive working by the additive manufacturing apparatus 100 according to the sixth embodiment described above, the control device 1 performs control for discharging the wire 5 to a non-contact position where the end of the wire 5 is not in contact with the process area 26 of the additive target surface 22, supply the wire 5 further to the process area 26, and subsequently irradiating the process area 26 with the laser beam 24. The non-contact position is a position located a distance aaway, which distance requires 0.2 seconds or more to be taken from the start of the supply of the wire 5 from the non-contact position to the process area 26 to the arrival of the end of the wire 5 at the process area 26.

By starting the supply operation of the wire 5 before the wire 5 is irradiated with the laser beam 24 as described above, it is possible to irradiate the wire 5 with the laser beam 24 at the same time as the wire 5 reaches the process area 26. The supply operation of the wire 5 has already been started by the time the radiation of the laser beam 24 is started, whereby the molten wire 21 is smoothly welded to the process area 26.

By starting the supply operation of the wire 5 before the wire 5 is irradiated with the laser beam 24, it is possible to irradiate the wire 5 with the laser beam 24 at the same time as the wire 5 reaches the process area 26. Consequently, the laser radiation time for forming the desired dot bead 32 can be shortened to the minimum limit of the laser radiation time required for forming the dot bead 32. As a result, the reduced-size dot bead 32 can be formed, and the dot bead 32 having a small diameter can be formed, so that the shape accuracy of the object 101 can be improved.

By starting the supply operation of the wire 5 before the wire 5 is irradiated with the laser beam 24, it is possible to use the exact prescribed value as the supply speed of the wire 5, so that the shape accuracy of the object 101 can be improved.

In step S610, the position of the end of the wire 5 is observed by the measurement system 61, and the discharge position of the end of the wire 5 is controlled so that the distance L1 is adjusted to the set value, whereby the distance L1 can be maintained at the set value. Consequently, the wire 5 can be irradiated with the laser beam 24 at the same time as the wire 5 reaches the process area 26, and the laser radiation time for forming the desired dot bead 32 can be shortened to the minimum limit of the laser radiation time required for forming the dot bead 32. As a result, the reduced-size dot bead 32 can be formed, and the dot bead 32 having a small diameter can be formed, so that the shape accuracy of the object 101 can be improved.

As described above, the additive working according to the sixth embodiment can achieve the effect that the molten wire 21 is smoothly welded to the process area 26, the molten wire 21 is thus stably welded to the additive target surface 22, thereby preventing the molten wire 21 from failing to be welded to the additive target surface 22.

### Seventh Embodiment

In the seventh embodiment, another mode of additive working by the additive manufacturing apparatus 100 illustrated in FIG. 1 will be described. The additive working according to the seventh embodiment differs from the additive working according to the first embodiment described above in that the supply speed of the wire 5 is increased.

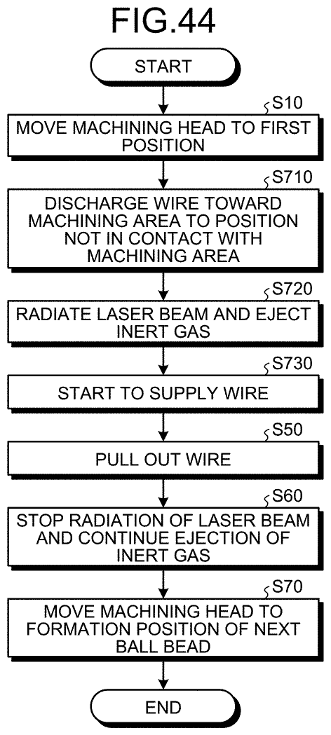

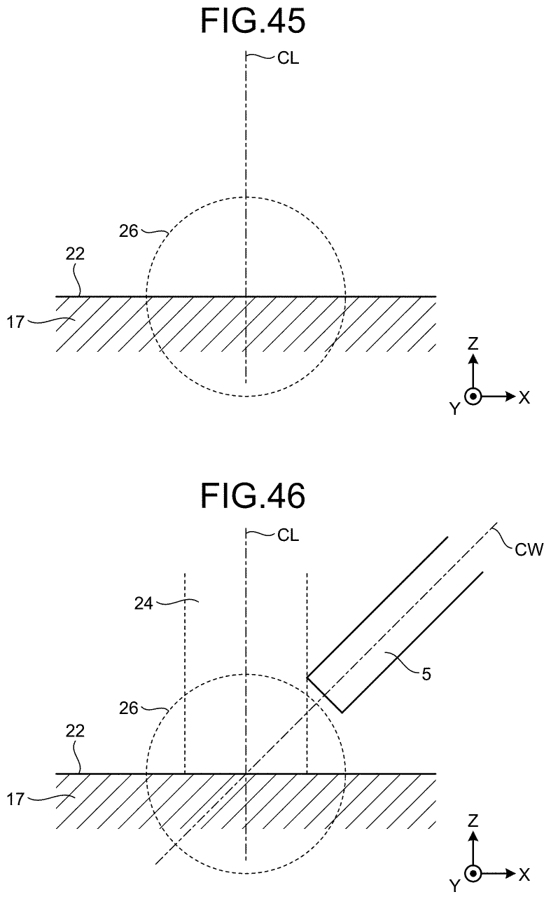

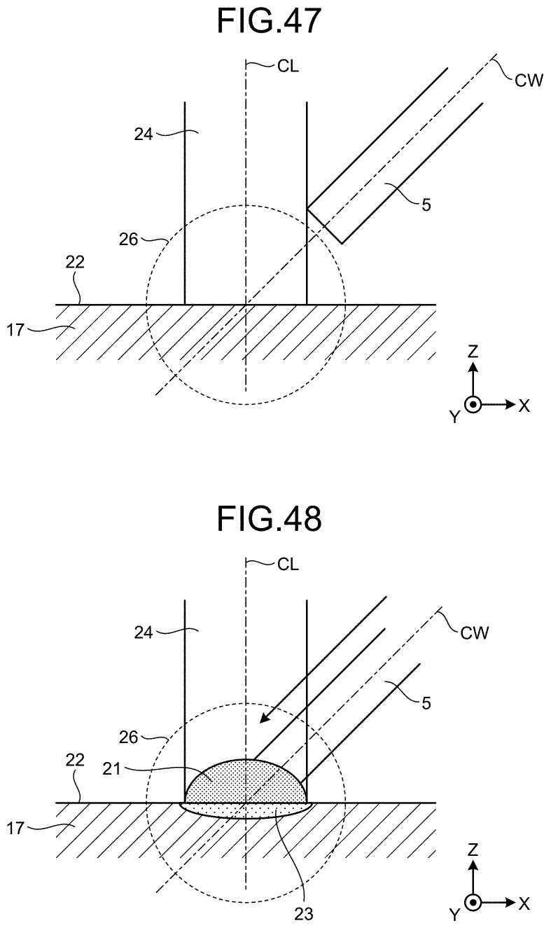

Hereinafter, additive working by the additive manufacturing apparatus 100 according to the seventh embodiment will be described with reference to FIGS. 44 to 48. FIG. 44 is a flowchart for explaining the operation of the additive manufacturing apparatus 100 illustrated in FIG. 1 according to the seventh embodiment. FIG. 45 is a schematic cross-sectional diagram illustrating the position of the central axis CL of the laser beam 24, with the working head 10 of the additive manufacturing apparatus 100 illustrated in FIG. 1 moved to the first position. FIG. 46 is a schematic cross-sectional diagram in which the wire 5 is discharged to a position where the end of the wire 5 is not in contact with the process area 26 in the additive manufacturing apparatus 100 illustrated in FIG. 1. FIG. 47 is a schematic cross-sectional diagram in which the irradiation of the process area 26 with the laser beam 24 is started in the additive manufacturing apparatus 100 illustrated in FIG. 1. FIG. 48 is a schematic cross-sectional diagram in which the supply of the wire 5 to the process area 26 of the additive manufacturing apparatus 100 illustrated in FIG. 1 is started. FIGS. 45 to 48 illustrate the state of a peripheral region of the process area 26 on the additive target surface 22.

First, as illustrated in FIG. 45, step S10 described above is performed.

Next, in step S710, the wire nozzle 12 discharges the wire 5 toward the process area 26 as illustrated in FIG. 46. Here, the wire 5 is discharged to a position where the end of the wire 5 is not in contact with the process area 26, that is, to a position where the end of the wire 5 is not in contact with the additive target surface 22. For example, the wire 5 is discharged to a position located the radius of the laser beam 24 radiated onto the process area 26, away from the central axis CL of the laser beam 24 radiated onto the process area 26, toward the wire nozzle 12. That is, the wire 5 is discharged to a position on the outer circumference of the laser beam 24 on a side of of the wire nozzle 12.

Note that before the supply of the wire 5 is started, the end of the wire 5 may be discharged to a position where the end of the wire 5 is not in contact with the additive target surface 22, the position being located outside the radius of the laser beam 24 radiated onto the process area 26 and on a wire-nozzle-side of the central axis CL of the laser beam 24 radiated onto the process area 26. Alternatively, before the supply of the wire 5 is started, the end of the wire 5 may be discharged to a position where the end of the wire 5 is within the radius of the laser beam 24 radiated onto the process area 26, but is not in contact with the additive target surface 22, the position being located on the wire-nozzle-side of the central axis CL of the laser beam 24 radiated onto the process area 26.

At this time, it is preferable that the central axis CW of the wire 5 discharged from the wire nozzle 12 and not in contact with the additive target surface 22 and the central axis CL of the laser beam 24 radiated onto the process area 26 intersect at the surface of the additive target surface 22. Alternatively, the central axis CW of the wire 5 intersect the surface of the additive target surface 22 within the beam radius of the laser beam 24 between the wire nozzle 12 and the central axis CL of the laser beam 24 radiated onto the process area 26. As a result, the dot bead 32 can be formed on the additive target surface 22 such that the formed dot bead has its center located on the intersection of the central axis CW of the wire 5 and the central axis CL of the laser beam 24 radiated onto the process area 26.

Next, in step S720, the laser beam 24 is radiated toward the process area 26 as illustrated in FIG. 47. In conjunction with the radiation of the laser beam 24, the ejection of the inert gas 25 from the gas nozzle 13 to the process area 26 is started.

Next, in step S730, the supply of the wire 5 to the process area 26 is started as illustrated in FIG. 48. That is, the wire nozzle 12 discharges the wire 5 further toward the process area 26. As a result, the wire 5 is delivered into the laser beam 24, and the wire 5 is melted. Then, the molten wire 21 is welded to the additive target surface 22, and the dot bead 32, which is the deposit 18, is formed in the process area 26 of the additive target surface 22.

In the seventh embodiment, the wire 5 is not in contact with the process area 26 in step S710. Therefore, in the seventh embodiment, as compared with the case of starting the supply of the wire 5 with the wire 5 in contact with the process area 26, extra heat is applied from the laser beam 24 during the period from the start of the supply of the wire 5 to the arrival of the end of the wire 5 at the process area 26. As a result, in the additive working according to the seventh embodiment, the supply speed of the wire 5 can be increased as compared with the case of starting the supply of the wire 5 with the wire 5 in contact with the process area 26. That is, in the additive working according to the seventh embodiment, the wire 5 is supplied at a faster supply speed than in the case of starting the supply of the wire 5 with the wire 5 in contact with the process area 26, such as the case of the first embodiment described above.

As a result, the additive working according to the seventh embodiment can prevent a run-up phenomenon in the molten wire 21 as well as increasing the spped at which to form the dot bead 32. The supply speed of the wire 5 in the additive working according to the seventh embodiment refers to the wire supply speed from the start of the supply of the wire 5 to the end of the supply of the wire 5, or the maximum rotation speed of the rotary motor 4.

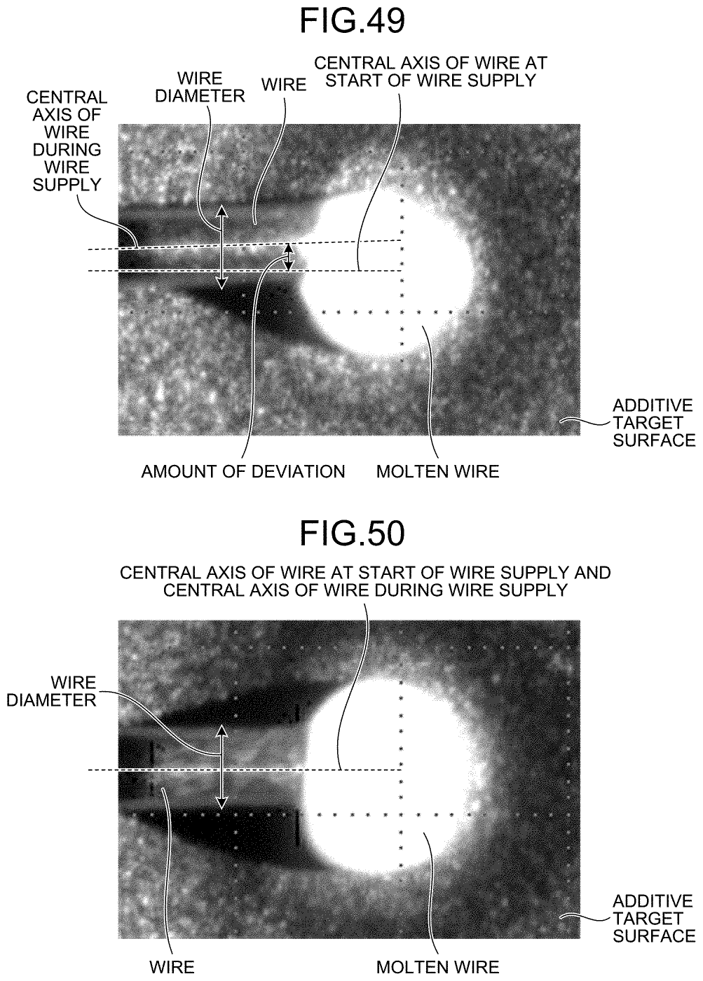

FIG. 49 is a diagram illustrating an image of the wire 5 supplied at an excessive supply speed in additive working by the additive manufacturing apparatus 100 illustrated in FIG. 1. FIG. 50 is a diagram illustrating an image of the wire 5 supplied at a normal supply speed in additive working by the additive manufacturing apparatus 100 illustrated in FIG. 1. A wire supply speed for the additive working according to the seventh embodiment is excessive in a case where the wire 5 is supplied at such a wire supply speed with the wire 5 in contact with the process area 26. This results in the phenomenon illustrated in FIG. 49 where the position of the central axis during the supply of the wire 5 deviates from the position of the central axis at the start of the supply of the wire 5, as viewed in the radiation direction of the laser beam 24.

The additive working according to the seventh embodiment is performed for the purpose of improving the shape accuracy of the dot bead 32 and improving the shape accuracy of the object 101. The supply speed of the wire 5 is determined to be excessive if the amount of deviation of the position of the central axis during the supply of the wire 5 from the position of the central axis at the start of the supply of the wire 5 exceeds 1/10 of the diameter of the wire 5. When the supply speed of the wire 5 is excessive, the wire 5 may deviate from the process area 26.

In contrast, in the additive working according to the seventh embodiment, as illustrated in FIG. 50, the position of the central axis during the supply of the wire 5 is the same as the position of the central axis at the start of the supply of the wire 5. That is, the phenomenon where the position of the central axis during the supply of the wire 5 deviates from the position of the central axis at the start of the supply of the wire 5 does not occur.

Therefore, in the additive working according to the seventh embodiment, the wire 5 is supplied at a speed that causes the position of the central axis during the supply of the wire 5 to deviate from the position of the central axis at the start of the supply of the wire 5 in a case where the supply operation of the wire 5 is started with the wire 5 in contact with the process area 26. More specifically, in the additive working according to the seventh embodiment, the wire 5 is supplied at a speed that causes the amount of deviation of the position of the central axis during the supply of the wire 5 from the position of the central axis at the start of the supply of the wire 5 to exceed 1/10 of the diameter of the wire 5 in a case where the supply operation of the wire 5 is started with the wire 5 in contact with the process area 26. As a result, in the additive working according to the seventh embodiment, it is possible to prevent a run-up phenomenon in the molten wire 21 as well as to increase the speed at which to form the dot bead 32, thereby increasing the speed at which to form the object 101.

After that, steps S50 to S70 described above are performed in the same manner as in the first embodiment as illustrated in FIGS. 9 to 11.

Note that the control method in steps S110 to S130 according to the second embodiment described above may be applied to the above-mentioned additive working.

As described above, the additive working according to the seventh embodiment can achieve the effect that a run-up phenomenon in the molten wire 21 does not occur, the speed at which to form the dot bead 32 becomes faster, and the speed at which to form the formed object 101 becomes faster.

The configurations described in the above-mentioned embodiments indicate examples of the contents of the present invention. The techniques of the embodiments can be combined with each other and with another well-known technique, and some of the configurations can be omitted or changed in a range not departing from the gist of the present invention.

### REFERENCE SIGNS LIST

1 control device; 2 laser oscillator; 3 fiber cable; 4 rotary motor; 5 wire; 6 wire spool; 7 gas supply device; 8 pipe; 10 working head; 11 beam nozzle; 12 wire nozzle; 13 gas nozzle; 14 head drive device; 15 stage; 16 rotation mechanism; 17 base material; 18 deposit; 19 wire supply unit; 21 molten wire; 22 additive target surface; 23 molten pool; 24 laser beam; 25 inert gas; 26 process area; 27a first dot bead layer; 27b second dot bead layer; 27c third dot bead layer; 32 dot bead; 41 CPU; 42 RAM; 43 ROM; 44 external storage device; 45 input/output interface; 46 bus; 51, 52, 53 arrow; 54 moving direction; 55 supply direction; 61 measurement system; 100 additive manufacturing apparatus; 101 object; 321, 322, 323, 324, 325, 326, 327, 328, 329, 3210, 3211, 3212, 3213, 3214, 3215 dot bead; A, B wire supply speed; C beam diameter; CL, CW central axis; D wire position ratio; E wire end distance; F wire supply angle; G wire supply distance; H arrival time; L distance.

1-25. (canceled)

26. An additive manufacturing apparatus to create an object on an additive target surface of a workpiece, the additive manufacturing apparatus comprising:
a material supplier to supply a build material to a process area of the additive target surface;
an irradiator to irradiate the process area with a laser beam to melt the build material; and
a controller to control the material supplier and the irradiator for irradiating the process area with the laser beam while supplying the build material to the process area to create at least a part of the object, using a dot-shaped bead, the dot-shaped bead being formed of the build material melted by radiation of the laser beam, wherein
the build material is wire-shaped,
the material supplier advances the wire-shaped build material in an oblique direction with respect to a direction perpendicular to an in-plane direction of the process area to supply the wire-shaped build material to the process area,
the irradiator directs the laser beam in the direction perpendicular to the in-plane direction of the process area to irradiate the process area with the laser beam, and
the controller performs control for bringing an end of the wire-shaped build material into contact with the process area, and subsequently irradiating the process area with the laser beam.

27. The additive manufacturing apparatus according to claim 26, wherein
the controller performs control for moving the wire-shaped build material toward a position lower than an actual height of the process area to thereby move the wire-shaped build material toward the process area to bring the end of the wire-shaped build material into contact with the process area after supplying the wire-shaped build material to a height position where the end of the wire-shaped build material is not in contact with the process area in a case where the wire-shaped build material is supplied to a position where the wire-shaped build material intersects a central axis of the laser beam, or after supplying the wire-shaped build material to a height position where the end of the wire-shaped build material is not in contact with the process area in a case where the wire-shaped build material is supplied to a position where a central axis of the wire-shaped build material is in contact with the process area.

28. An additive manufacturing apparatus to create an object on an additive target surface of a workpiece, the additive manufacturing apparatus comprising:
a material supplier to supply a build material to a process area of the additive target surface;
an irradiator to irradiate the process area with a laser beam to melt the build material; and
a controller to control the material supplier and the irradiator for irradiating the process area with the laser beam while supplying the build material to the process area to create at least a part of the object, using a dot-shaped bead, the dot-shaped bead being formed of the build material melted by radiation of the laser beam, wherein
the build material is wire-shaped,
the controller performs control for irradiating the process area with the laser beam and supplying the wire-shaped build material to the process area after supplying the wire-shaped build material to a standby position where a distance between a central axis of the laser beam and an end of the wire-shaped build material in an in-plane direction of the additive target surface is in a range of 0.5 to 2.3 times a radius of the laser beam in a case where the laser beam and a central axis of the wire-shaped build material are non-coaxial, or after supplying the wire-shaped build material to a standby position where a distance between the additive target surface and the end of the wire-shaped build material is in the range of 0.5 to 2.3 times the radius of the laser beam in a case where the laser beam and the central axis of the wire-shaped build material are coaxial, and wherein
the standby position is a position where the wire-shaped build material is not heated by the laser beam to above a melting point of the wire-shaped build material before supply of the wire-shaped build material to the process area is started after the process area is irradiated with the laser beam, and
in a case where the additive target surface is a second or higher-order dot-shaped bead layer providing the object,
before radiating the laser beam, the controller moves the wire-shaped build material upward to a height position on a basis of a height of the additive target surface and a height of an end position of the wire-shaped build material supplied to the standby position, the height position enabling the end of the wire-shaped build material to reach a position of the central axis of the laser beam that is to be radiated onto the process area, and subsequently the controller further supplies the wire-shaped build material to the process area.

29. The additive manufacturing apparatus according to claim 26, wherein
the controller performs control for stopping supply of the wire-shaped build material and radiation of the laser beam after irradiating the process area with the laser beam for a predetermined radiation time while supplying the wire-shaped build material to the process area, with a supply position of the wire-shaped build material being fixed.

30. The additive manufacturing apparatus according to claim 28, wherein
the controller performs control for stopping supply of the wire-shaped build material and radiation of the laser beam after irradiating the process area with the laser beam for a predetermined radiation time while supplying the wire-shaped build material to the process area, with a supply position of the wire-shaped build material being fixed.

31. The additive manufacturing apparatus according to claim 26, wherein
after stopping supply of the wire-shaped build material, the controller performs control for pulling out the wire-shaped build material in a direction opposite to a supply direction of the wire-shaped build material and stopping radiation of the laser beam.

32. The additive manufacturing apparatus according to claim 28, wherein
after stopping supply of the wire-shaped build material, the controller performs control for pulling out the wire-shaped build material in a direction opposite to a supply direction of the wire-shaped build material and stopping radiation of the laser beam.

33. The additive manufacturing apparatus according to claim 29, comprising
a gas supplier to eject an inert gas to the process area under control of the controller, wherein
the controller performs control for ejecting the inert gas to the process area during a period in which the process area is irradiated with the laser beam and for a predetermined duration after radiation of the laser beam is stopped.

34. The additive manufacturing apparatus according to claim 33, wherein
the controller performs control for stopping ejection of the inert gas after a lapse of the duration until a next radiation of the laser beam.

35. The additive manufacturing apparatus according to claim 26, wherein
the controller moves the wire-shaped build material upward to such an extent that the wire-shaped build material is not pulled out from a molten wire, the molten wire being the melted wire-shaped build material welded to the process area.

36. The additive manufacturing apparatus according to any claim 28, wherein
the controller moves the wire-shaped build material upward to such an extent that the wire-shaped build material is not pulled out from a molten wire, the molten wire being the melted wire-shaped build material welded to the process area.

37. The additive manufacturing apparatus according to claim 35, wherein
after moving the wire-shaped build material upward, the controller performs control for pulling out the wire-shaped build material in a direction opposite to a supply direction of the wire-shaped build material.

38. The additive manufacturing apparatus according to claim 26, wherein
the controller controls a moving direction of the material supplier and a supply direction of the wire-shaped build material such that the material supplier moves and the wire-shaped build material is supplied in such directions as not to allow the wire-shaped build material supplied to the process area to overlap the dot-shaped bead already formed on the additive target surface, in a plane of the additive target surface.

39. The additive manufacturing apparatus according to claim 28, wherein
the controller controls a moving direction of the material supplier and a supply direction of the wire-shaped build material such that the material supplier moves and the wire-shaped build material is supplied in such directions as not to allow the wire-shaped build material supplied to the process area to overlap the dot-shaped bead already formed on the additive target surface, in a plane of the additive target surface.

40. The additive manufacturing apparatus according to claim 26, comprising
a first motor capable of rotating the workpiece or a second motor to move the material supplier and the irradiator in a circle in an in-plane direction of the additive target surface, wherein
the controller controls a supply direction of the wire-shaped build material and a rotation direction of the workpiece such that the wire-shaped build material is supplied and the workpiece is rotated in such directions as not to allow the wire-shaped build material supplied to the process area to overlap the dot-shaped bead already formed on the additive target surface, in a plane of the additive target surface.

41. The additive manufacturing apparatus according to claim 28, comprising
a first motor capable of rotating the workpiece or a second motor to move the material supplier and the irradiator in a circle in an in-plane direction of the additive target surface, wherein
the controller controls a supply direction of the wire-shaped build material and a rotation direction of the workpiece such that the wire-shaped build material is supplied and the workpiece is rotated in such directions as not to allow the wire-shaped build material supplied to the process area to overlap the dot-shaped bead already formed on the additive target surface, in a plane of the additive target surface.

42. The additive manufacturing apparatus according to claim 26, wherein
the controller performs control for forming a plurality of first dot-shaped beads with a gap between adjacent dot-shaped beads, and subsequently forming a second dot-shaped bead in the gap or an area adjacent to the first dot-shaped beads.

43. The additive manufacturing apparatus according to claim 26, wherein
the controller performs control for forming a plurality of the dot-shaped beads that provide a dot-shaped bead layer, the plurality of the dot-shaped beads including a dot-shaped bead corresponding to an edge of the dot-shaped bead layer, the controller performing control for forming the dot-shaped bead corresponding to the edge later than any other dot-shaped beads of the dot-shaped bead layer.

44. The additive manufacturing apparatus according to claim 28, wherein
the controller performs control for forming a plurality of the dot-shaped beads that provide a dot-shaped bead layer, the plurality of the dot-shaped beads including a dot-shaped bead corresponding to an edge of the dot-shaped bead layer, the controller performing control for forming the dot-shaped bead corresponding to the edge later than any other dot-shaped beads of the dot-shaped bead layer.

45. An additive manufacturing apparatus to create an object on an additive target surface of a workpiece, the additive manufacturing apparatus comprising:
a material supplier to supply a build material to a process area of the additive target surface;
an irradiator to irradiate the process area with a laser beam to melt the build material; and
a controller to control the material supplier and the irradiator for irradiating the process area with the laser beam while supplying the build material to the process area to create at least a part of the object, using a dot-shaped bead, the dot-shaped bead being formed of the build material melted by radiation of the laser beam, wherein
the build material is wire-shaped, and
the controller performs control for starting to supply, to the process area, the wire-shaped build material not heated using a heat source, the heat source being capable of melting the modeling material supplied to the machining area to form the object, and subsequently irradiating the process area with the laser beam.

46. The additive manufacturing apparatus according to claim 45, wherein
the controller performs control for discharging the non-heated wire-shaped build material to a non-contact position where an end of the non-heated wire-shaped build material is not in contact with the process area, starting to supply the non-heated wire-shaped build material further to the process area, and subsequently irradiating the process area with the laser beam.

47. The additive manufacturing apparatus according to claim 46, wherein the non-contact position is a position where a distance between the non-heated wire-shaped build material and the process area is equal to or larger than a distance by which the non-heated wire-shaped build material is supplied during a time in which a supply speed of the non-heated wire-shaped working material reaches a prescribed value after supply of the non-heated wire-shaped working material is started.

48. The additive manufacturing apparatus according to claim 47, wherein
the non-contact position is a position located a distance away, which distance requires 0.2 seconds or more to be taken from start of supply of the non-heated wire-shaped build material from the non-contact position to the process area to arrival of the end of the non-heated wire-shaped build material at the process area.

49. The additive manufacturing apparatus according to claim 45, wherein
on the basis of an observation result of a position of the end of the non-heated wire-shaped build material, the controller controls a timing at which to irradiate the process area with the laser beam.

50. An additive manufacturing apparatus to create an object on an additive target surface of a workpiece, the additive manufacturing apparatus comprising:
a material supplier to supply a build material to a process area of the additive target surface;
an irradiator to irradiate the process area with a laser beam to melt the build material; and
a controller to control the material supplier and the irradiator for irradiating the process area with the laser beam while supplying the build material to the process area to create at least a part of the object, using a dot-shaped bead, the dot-shaped bead being formed of the build material melted by radiation of the laser beam, wherein
the build material is wire-shaped,
the controller performs control for discharging the wire-shaped build material to a position where an end of the wire-shaped build material is not in contact with the process area, irradiating the process area with the laser beam, and subsequently supplying the wire-shaped build material further to the process area, and
after irradiating the process area with the laser beam, the controller supplies the wire-shaped build material to the process area at a speed that causes the end of the wire-shaped build material to deviate from the process area with the process area irradiated with the laser beam in a case where the wire-shaped build material is supplied to the process area with the end of the wire-shaped build material in contact with the process area.

51. An additive manufacturing apparatus to create an object on an additive target surface of a workpiece, the additive manufacturing apparatus comprising:
a material supplier to supply a build material to a process area of the additive target surface;
an irradiator to irradiate the process area with a laser beam to melt the build material; and
a controller to control the material supplier and the irradiator for irradiating the process area with the laser beam while supplying the build material to the process area to create at least a part of the object, using a dot-shaped bead, the dot-shaped bead being formed of the build material melted by radiation of the laser beam, wherein
the build material is wire-shaped,
the controller performs control for bringing an end of the wire-shaped build material into contact with the process area, and subsequently irradiating the process area with the laser beam, and
the controller moves the wire-shaped build material upward to such an extent that the wire-shaped build material is not pulled out from a molten wire, the molten wire being the melted wire-shaped build material welded to the process area.

52. The additive manufacturing apparatus according to claim 51, wherein
after moving the wire-shaped build material upward, the controller performs control for pulling out the wire-shaped build material in a direction opposite to a supply direction of the wire-shaped build material.

53. An additive manufacturing method for performing additive working to thereby create an object on an additive target surface of a workpiece, the additive working including irradiating a process area of the additive target surface of the workpiece with a laser beam while supplying a build material to the process area by controlling: a material supplier to supply the build material to the process area of the additive target surface of the workpiece; and an irradiator to irradiate the additive target surface with the laser beam to melt the build material,
the additive manufacturing method comprising a step of forming a dot-shaped bead by melting the build material by radiation of the laser beam, wherein
the build material is wire-shaped, and
the step of forming the dot-shaped bead includes:
a step of starting to supply, to the process area, the wire-shaped build material not heated using a heat source, the heat source being capable of melting the modeling material supplied to the machining area to form the object; and
a step of irradiating the process area with the laser beam after starting to supply the non-heated wire-shaped build material to the process area.

54. An additive manufacturing method for performing additive working to thereby create an object on an additive target surface of a workpiece, the additive working including irradiating a process area of the additive target surface of the workpiece with a laser beam while supplying a build material to the process area by controlling: a material supplier to supply the build material to the process area of the additive target surface of the workpiece;
and an irradiator to irradiate the additive target surface with the laser beam to melt the build material,
the additive manufacturing method comprising a step of forming a dot-shaped bead by melting the build material by radiation of the laser beam, wherein
the build material is wire-shaped,
the step of forming the dot-shaped bead includes:
a step of discharging the wire-shaped build material to a position where an end of the wire-shaped build material is not in contact with the process area;
a step of irradiating the process area with the laser beam; and
a step of supplying the wire-shaped build material to the process area, and
in the step of supplying the wire-shaped build material to the process area, the wire-shaped build material is supplied to the process area at a speed that causes the end of the wire-shaped build material to deviate from the process area with the process area irradiated with the laser beam in a case where the wire-shaped build material is supplied further to the process area with the end of the wire-shaped build material in contact with the process area.

55. An additive manufacturing method for performing additive working to thereby create an object on an additive target surface of a workpiece, the additive working being performed by controlling: a material supplier to supply a wire-shaped build material to a process area of the additive target surface of the workpiece; and an irradiator to irradiate the additive target surface with a laser beam that melts the build material, the additive manufacturing method comprising:
a step of supplying the wire-shaped build material to a standby position where a distance between a central axis of the laser beam and an end of the wire-shaped build material in an in-plane direction of the additive target surface is in a range of 0.5 to 2.3 times a radius of the laser beam in a case where the laser beam and a central axis of the wire-shaped build material are non-coaxial, or supplying the wire-shaped build material to a standby position where a distance between the additive target surface and the end of the wire-shaped build material is in the range of 0.5 to 2.3 times the radius of the laser beam in a case where the laser beam and the central axis of the wire-shaped build material are coaxial;
a step of irradiating the process area with the laser beam; and
a step of supplying the wire-shaped build material to the process area, wherein
the standby position is a position where the wire-shaped build material is not heated by the laser beam to above a melting point of the wire-shaped build material before supply of the wire-shaped build material to the process area is started after the process area is irradiated with the laser beam, and
in a case where the additive target surface is a second or higher-order dot-shaped bead layer providing the object,
before radiating the laser beam, the wire-shaped build material is moved upward to a height position on a basis of a height of the additive target surface and a height of an end position of the wire-shaped build material supplied to the standby position, the height position enabling the end of the wire-shaped build material to reach a position of the central axis of the laser beam that is to be radiated onto the process area, and subsequently the wire-shaped build material is further supplied to the process area.
